(19) United States
(12) Patent Application Publication
(10) Pub. No.: US 2007/0116643 A1
(43) Pub. Date: May 24, 2007

(54) Novel aryloxypropanamines

(75) Inventor: Roger Tung, Lexington, MA (US)

Correspondence Address: EDWARDS & ANGELL, LLP, P.O. BOX 55874, BOSTON, MA, 02205, US

(73) Assignee: Concert Pharmaceuticals Inc., La Jolla, CA (US)

(21) Appl. No.: 11/480,324

(22) Filed: Jun. 30, 2006

Related U.S. Application Data
(60) Provisional application No. 60/696,214, filed on Jul. 1, 2005.

(51) Int. Cl. C01B 4/00

(52) U.S. Cl. 423/647.7

(57) ABSTRACT

The present invention relates to an aryloxypropanamine containing one or more deuterium or ¹³C in place of a hydrogen or carbon, respectively. These isotopic aryloxypropanamines of the invention are inhibitors of serotonin and norepinephrine uptake and possess unique biopharmaceutical and pharmacokinetic properties compared to the responding light atom isotopologues. The invention further provides compositions comprising these isotopic aryloxypropanamines and methods of treating diseases and conditions linked to reduced neurotransmission of norepinephrine and/or serotonin. It further provides methods for using these isotopic aryloxypropanamines to accurately determine the concentration of the light atom isotopologues in biological fluids and of studying the metabolism of the light atom isotopologues.

### RELATED APPLICATION

This application claims the benefit of U.S. provisional patent application Ser. No. 60/696,214 filed on Jul. 1, 2005.

### TECHNICAL FIELD OF THE INVENTION

The present invention relates to an aryloxypropanamine in which one or more hydrogen attached to a carbon has been replaced with deuterium. These heavy atom-containing aryloxypropanamines of the invention are inhibitors of serotonin and norepinephrine uptake and possess unique biopharmaceutical and pharmacokinetic properties compared to the corresponding all-light atoms isotopologues. The invention further provides compositions comprising these heavy atom-containing aryloxypropanamines and methods of treating diseases and conditions that have been linked to reduced neurotransmission of serotonin and/or norepinephrine. The invention also provides methods of using the compounds of this invention to determine metabolic liabilities of the all-light atom species and their extraction efficiencies from biological milieu.

### BACKGROUND OF THE INVENTION

Aryloxypropanamines, of the formula: 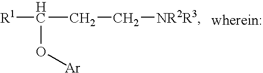
R¹ is C₅-C₇ cycloalkyl, thienyl, halothienyl, (C₁-C₄ alkyl) thienyl, furanyl, pyridyl or thiazolyl;
Ar is 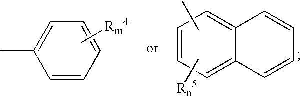
each of R² and R³ independently is hydrogen or methyl; each R⁴ independently is halo, C₁-C₄ alkyl, C₁-C₃ alkoxy or trifluoromethyl; each R⁵ independently is halo, C₁-C₄ alkyl or trifluoromethyl; m is 0, 1 or 2; n is 0 or 1; and the pharmaceutically acceptable acid addition salts thereof are disclosed as useful inhibitors of serotonin (5-HT) and norepinephrine (NE) uptake, with utility as psychotropic agents, particularly antidepressants (Robertson D W et. al. U.S. Pat. No. 5,023,269 to Eli Lilly).

In particular, Compound A, chemically described variously as (+)-(S)-N-methyl-γ-(1-naphthyloxy)-2(thiophenenepropylamine hydrochloride; (S)-N-methyl-3-(naphthalen-1-yloxy)-3-(thiophen-2-yl)propan-1-amine hydrochloride; and (+)-(S)-N-methyl-N-[3-(naphthalen-1-yloxy)-3-(2-thienyl)propyl]amine hydrochloride; has been approved by the US Food and Drug Administration for the treatment of depression and diabetic neuropathy pain (New Drug Application No. 021427 http://www.fda.gov/cder/foi/label/2004/217331bl.pdf)

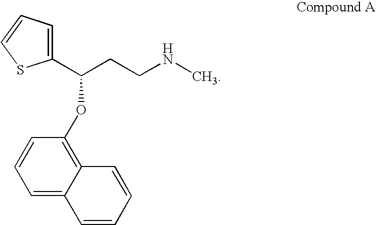

Compound A was the first agent to be approved for the latter indication, and provides important and substantial therapeutic benefits (FDA Press Release P04-87, http://www.fda.gov/bbs/topics/news/2004/NEW01113.html). Compound A is also useful for the treatment of attention-deficit/hyperactivity disorder, fibromyalgia, psoriasis, interstitial cystitis, incontinence, and providing cardiovascular benefit through reduction of platelet activation state (Heiligenstein J H et. al. U.S. Pat. No. 5,696,168 to Eli Lilly; Thor K B U.S. Pat. No. 5,744,474 to Eli Lilly; Iyengar S et. al. U.S. Pat. No. 6,150,396 to Eli Lilly; Goldstein D J et. al., U.S. Pat. No. 6,596,756 to Eli Lilly; Thomasson H R, U.S. Pat. No. 6,683,114 to Eli Lilly; Serebruany V L, U.S. Pat. No. 6,552,014 et al. to Eli Lilly).

Combinations with additional agents are known to further extend the utility of Compound A in the treatment or prevention of depression, obsessive-compulsive disease, aggressive disorder, premature ejaculation, cardiovascular disease, urinary tract disorders, psychosis, acute mania, anxiety, pain, and sleep disorders, by reducing its associated gastrointestinal side-effects or by potentiating its drug activity, (Wong D T et al., U.S. Pat. No. 5,532,244 to Eli Lilly; Wong D T et al., U.S. Pat. No. 5,532,250 to Eli Lilly; Wong D T et al., U.S. Pat. No. 5,532,264 to Eli Lilly; James S P, U.S. Pat. No. 5,776,969 to Eli Lilly; Shannon H E et al., U.S. Pat. No. 5,945,416 to Eli Lilly; Wong D T, U.S. Pat. No. 5,958,429 to Eli Lilly; Wong D T, U.S. Pat. No. 5,958,429 to Lilly; Meulemans A L G et al., U.S. Pat. No. 5,990,159 to Janssen; Perry K W, U.S. Pat. No. 6,066,643 to Eli Lilly; Bymaster F P et al., U.S. Pat. No. 6,147,072 to Lilly; Iyengar S et al., U.S. Pat. No. 6,245,802 to Eli Lilly; Wilson L F et. al., U.S. Pat. No. 6,403,597 to Vivus, Inc.; Schildkraut, J J and Mooney J J, U.S. Pat. No. 6,403,645 to Harvard College; Hertel L W et al., U.S. Pat. No. 6,436,964 to Eli Lilly; Helton D R et. al., U.S. Pat. No. 6,444,665 to Eli Lilly; Jerussi T P, U.S. Pat. No. 6,489,341 to Sepracor Inc.; Bruns, Jr. R F et al., U.S. Pat. No. 6,521,611 to Eli Lilly; Mehanna A S et al., U.S. Pat. No. 6,541,479 to Massachusetts College of Pharmacy; Blakemore D C et al., U.S. Pat. No. 6,596,900 to Pfizer; Gilbert A M et al., U.S. Pat. No. 6,656,951 to Wyeth; Stack G P et al., U.S. Pat. No. 6,815,448 to Wyeth; Stack G P et al., U.S. Pat. No. 6,861,427 to Wyeth; Landau S B et al., U.S. Pat. No. 6,846,823 to Dynogen; Wrobleski M L et al., U.S. Pat. No. 6,878,732 to Schering Corporation). Each of the patents cited in this disclosure are incorporated in their entirety herein by reference.

Compound A has been characterized in rodent models as inhibiting neural cell firing by reducing reuptake of 5-HT. It also is a high affinity NE reuptake inhibitor, but lacks affinity for central monoamine receptors (Wong D T et. al., Neuropsychopharmacology 1993 8: 23; Fuller R W et. al., J. Pharmacol. Exp. Ther. 1994 269: 132; Kasamo K et. al., J. Pharmacol. Exp. Ther. 1996 277: 278.) In the forced swim test animal model, Compound A demonstrates potent attenuation of immobility, a predictive model for antidepressant activity (Karpa K D et. al., CNS Drug Rev. 2002 8: 361; Reneric J P and Lucki I, Psychopharmacology 1998 136: 190). In humans, Compound A recapitulates the preclinically observed inhibition of 5-HT and NE reuptake, and demonstrates potent antidepressant activity (Chalon S A et. al., Neuropsychopharmacology 2003 28:1685.

Following oral administration to humans, Compound A is rapidly and extensively metabolized by predominantly oxidative mechanisms (Lantz R A, et. al., Drug Metab. Dispos. 2003 31:1142), the major initial metabolites being ring oxidation on the naphthylenyl ring, followed by secondary ring oxidation and Phase II conjugations and urinary excretion. The conjugated metabolites and major identified ring oxidation products have substantially attenuated or immeasurably poor activity against the transporters believed to be responsible for the neurological activity of Compound A (Kuo F, et. al., Bioorg. Med. Chem. Lett. 2004 14: 3481). This oxidation is reportedly mediated mainly by two isozymes of cytochrome P450, namely, CYP2D6 and CYP1A2 (New Drug Application No. 021427 dated 9/30/04: http://www.fda.gov/cder/foi/label/2004/217331bl.pdf). Demethylation of the amine group also occurs to an unknown extent, forming an inactive metabolite. Following administration of radiolabeled Compound A, only approximately 3% of the circulating radioactivity, on an area under the time-plasma concentration curve (AUC) basis, was attributable to parent drug, indicating the extent to which metabolism affects exposure to the parent drug. Thus, it is clear that the biochemical oxidative lability of Compound A is a factor in limiting this drug's potency and preventing lower doses from exhibiting sufficient efficacy.

It is therefore desirable to create a compound displaying the beneficial activities of Compound A, but that will display a reduced rate of metabolism following administration to a patient. Finding a way to reduce one or both of oxidation at the naphthylenyl ring and oxidative N-demethylation should create a particularly useful new chemical entity.

### SUMMARY OF THE INVENTION

The present invention solves the problems set forth above by providing a compound of Formula I: 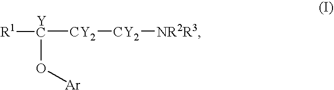
or a pharmaceutically acceptable acid addition salt thereof, wherein:
each Y is independently selected from H or deuterium;
R¹ is C₅-C₇ cycloalkyl, thienyl, halothienyl, (C₁-C₄ alkyl) thienyl, furanyl, pyridyl, thiazolyl;
Ar is 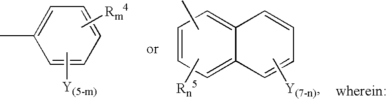
   each R⁴ is independently selected from halo, C₁-C₄ alkyl, C₁-C₃ alkoxy or trifluoromethyl;
   each R⁵ is independently selected from halo, C₁-C₄ alkyl or trifluo-romethyl;
   m is 0, 1 or 2; and
   n is 0 or 1;
each of R² and R³ is independently selected from hydrogen, deuterium or CY₃;
each carbon atom is optionally replaced with ¹³C;
   wherein at least one Y is deuterium.

Applicant has discovered that the replacement of one or more hydrogen atoms with deuterium in a compound of formula I results in a compound with different and, in certain compounds, superior properties. These compounds, and compositions comprising them, are useful for treating or lessening the severity of disorders characterized by reduced interstitial concentrations of serotonin or norepinephrine. The compounds and compositions of this invention are also useful as analytical reagents for determining the concentration of the corresponding non-deuterated, non-¹³C compound in solution. The term “corresponding non-deuterated, non-¹³C compound” as used herein refers to a compound wherein all Y are hydrogen and all carbon atoms are ¹²C.

The exchange of deuterium in place of hydrogen in an organic molecule typically alters its intrinsic physicochemical properties. This is due to the increased mass of deuterium relative to hydrogen and lowered vibrational frequency of molecular bonds involving deuterium relative to those involving hydrogen (Thomton E R, Ann. Rev. Phys. Chem. 1966 17: 349-372; Halevi, E A et. al. J. Chem. Soc. 1963: 866; Cuma M and Scheiner C, J. Phys. Org. Chem. 1997 10: 383). This change is manifested by numerous physical differences, such as chromatographic behavior, hydrophobicity, hydrogen bond strength, and phase transition temperatures. As an example, deuterium oxide (D₂O, the deuterium analog of water) melts at 3.8° C. in contrast to water, which melts at 0° C., and is more viscous than water. Similarly, hexadeuterated dimethylsulfoxide (DMSO-d₆) melts at a higher temperature, but boils at a lower temperature than its non-deuterated analog. Typically, deuterated compounds will elute faster by reverse-phase HPLC than nondeuterated compounds, apparently due to reduced hydrophobic interactions with the column packing, although the physical chemistry leading to this observed difference is complex (Turowski M et. al., J. Am. Chem. Soc. 2003 125: 13836).

Incorporation of deuterium in place of hydrogen also has significant effects on the physiological and pharmacological activities of the substituted compound. For instance, N-nitrosamines substituted with deuterium can display increased, decreased, or unchanged carcinogenicity depending on where in the compound hydrogen is replaced with deuterium and on the identity of the compound to which substitutions are made (Lijinsky W et. al. Food Cosmet. Toxicol. 1982 20: 393; Lijinsky W et. al. JCNI 1982 69: 1127). Similarly, both increases and decreases in bacterial mutagenicity of deuterium-substituted aza-amino acids are known, depending on the identity of the amino acid derivative and position of substitution (Mangold J B et. al. Mutation Res. 1994 308: 33). Reduced hepatotoxicity of certain deuterium-substituted compounds is known (Gordon W P et. al. Drug Metab. Dispos.1987 15: 589; Thompson D C et. al. Chem. Biol. Interact. 1996 101: 1). Deuterium substitution can affect the odor of a compound (Turin L, Chem. Senses 1996 21: 773) and plasma protein binding (Echmann M L et. al. J. Pharm. Sci. 1962 51: 66; Cherrah Y. et. al. Biomed. Environm. Mass Spectrom. 1987 14: 653; Cherrah Y. et. al. Biochem. Pharmacol. 1988 37: 1311). Changes in the biodistribution and clearance of certain deuterium and ¹³C-substituted compounds suggests changes in their recognition by active transport mechanisms (Zello G A et. al. Metabolism 1994 43: 487; Gately S J et. al. J. Nucl. Med. 1986 27: 388; Wade D, Chem. Biol. Interact. 1999 117: 191).

Replacement of hydrogen with deuterium at sites subject to oxidative metabolism by, for instance, heme proteins such as cytochrome P450 and peroxidase enzymes, is known in certain, but not all, cases to produce a significant reduction in the rate of metabolism due to the primary isotope effect of breaking the C—¹H versus C—²H bond (Guengerich F P et. al. J. Biol. Chem. 2002 277: 33711; Kraus, J A and Guengerich, F P, J. Biol. Chem. (Web edition) 2005 280: 19496; Mitchell K H et. al., Proc. Natl. Acad. Sci. USA 2003 109: 3784; Nelson S D and Trager W F, Drug Metab. Dispos. 2003 31: 1481; Hall L R and Hanzlik, R P J. Biol. Chem. 1990 265: 12349; Okazaki O. and Guengerich F P J. Biol. Chem. 268, 1546; Iwamura S et. al. J. Pharmacobio-Dyn. 1987 10: 229). If the C—H bond breaking step is rate-limiting a substantial isotope effect can be observed. If other steps determine the overall rate of reaction, the isotope effect may be insubstantial. In cases where a rate limiting step of a reaction involves rehybridization of the attached carbon from sp2 to sp3, deuterium substitution often creates a negative isotope effect, speeding up the reaction rate.

Isotope effects caused by substitution of ¹³C for ¹²C can also affect the rate of C—H bond cleavage by enzymatic oxidation. It is further believed that ¹³C substitution combined with deuterium substitution where the two isotopes are bonded to one another (e.g. ¹³C—²H) can be of value due to further stabilizing the C—H bond and thus reducing susceptibility to oxidative metabolism.

¹⁴C-Labeled Compound A has been described for use in metabolism studies (Wheeler W J and Kuo F, J. Labelled Compd Radiopharm 1995, 36: 213). However the radioactive isotopes ³H and ¹⁴C are physiologically harmful in significant doses and are not useful in routine medicaments.

Although incorporation of stable heavy atoms into specific organic compounds can change their pharmacological properties, general exposure to and incorporation of stable heavy atoms is safe within levels potentially achieved by use of compounds of this invention as medicaments. For instance, the percentages of hydrogen and carbon in a mammal (approximately 9% and 18% by weight, respectively) and natural abundances of deuterium and ¹³C (0.015% and 1.11%, respectively) indicate that a 70 kg human normally contains nearly a gram of deuterium and approximately 140 g of ¹³C. Furthermore, replacement of up to about 15% of normal hydrogen with deuterium has been effected and maintained for a period of days to weeks in mammals, including rodents and dogs, with minimal observed adverse effects (Czajka D M and Finkel A J, Ann. N.Y. Acad. Sci. 1960 84: 770; Thomson J F, Ann. N.Y. Acad. Sci 1960 84: 736; Czakja D M et. al., Am. J. Physiol. 1961 201: 357). Higher deuterium concentrations, usually in excess of 20%, can be toxic in animals. However, brief replacement of as high as 23% of the hydrogen in humans' fluids with deuterium was found not to cause toxicity (Blagojevic N et. al. in “Dosimetry & Treatment Planning for Neutron Capture Therapy”, Zamenhof R, Solares G and Harling O Eds. 1994. Advanced Medical Publishing, Madison Wis. pp.125-134). In a 70 kg human male, 15% replacement of the hydrogen in the fluid compartment with deuterium corresponds to incorporation of approximately 1 kg of deuterium or the equivalent of approximately 5 kg of deuterated water. Replacement of 15% of all of the body's hydrogen with deuterium, as effected in animal studies, would correspond to about twice that amount of deuterium incorporation. These levels are orders of magnitude beyond the conceived level of administration of any of the deuterium-containing compounds of this invention.

Similarly, replacement of up to 60% of the normally abundant ¹²C with ¹³C has been effected in mice without any observed adverse effects (Gregg C T et. al., Life Sci. 1973 13: 775; Gregg C et. al. in Klein E R and Klein P D (eds.) Proceedings of the Second International conference on Stable Isotopes, US Department of Commerce; Springfield Va., 1975, pp 64-75). Stable isotope tracers, such as ¹³C-labeled glucose and repeated doses of hundreds to thousands of milligrams of deuterated water, are used in humans of all ages, including babies and pregnant women, without reported incident (Pons G and Rey E, Pediatrics 1999 104: 633; Coward W A et. al., Lancet 1979 7: 13; Schwarcz H P, Control. Clin. Trials 1984 5(4 Suppl): 573; Rodewald L E et. al., J. Pediatr. 1989 114: 885; Butte N F et. al. Br. J. Nutr. 1991 65: 3). Thus, it is clear that any stable heavy isotope released, for instance, during the metabolism of compounds of this invention poses no health risk.

Without being bound by theory, applicant believes that the novel compounds of this invention will demonstrate altered and even unexpectedly superior properties as compared to the corresponding non-deuterated, non-¹³C compounds. Oxidative metabolism, plasma protein binding, hydrophobicity, hydrogen bond strength, polarizability, and phase transition points are each important parameters contributing to the effectiveness or manufacturability of pharmacological agents. It is predicted that one or more of these altered properties will translate into superior biological, chemical and/or pharmacokinetic properties for a compound of this invention as compared to the corresponding non-deuterated, non-¹³C compounds.

Such altered properties include, but are not limited to, higher potency, longer biological half life, increased safety profile, enhanced penetration into the CNS, decreased desolvation energy, enhanced receptor binding affinity, increased physicochemical stability, and enhanced shelf life. It is expected that the compounds of this invention will exhibit one or more of such altered and desirable properties.

These altered properties will not, however, obliterate the ability of the compounds of this invention to bind to their receptor targets. This is because such receptor binding is primarily dependent upon non-covalent binding between the receptor and the inhibitor, and any negative effects that a heavy atom may have on the highly optimized non-covalent binding between compounds of Formula I and the norepinephrine and serotonin uptake machinery will be minor.

Major factors contributing to the noncovalent recognition of small molecules by proteins and the binding strength between them include Van der Waals forces, hydrogen bonds, ionic bonds, molecular reorganization, desolvation energy of the small molecule, hydrophobic interactions, and in certain instances displacement energy for pre-existing bound ligands. See, for instance, Goodman & Gilman's The Pharmacological Basis of Therapeutics, Tenth Edition, Hardman J G and Limbird L E, eds. McGraw-Hill, 2001.

The compounds of this invention possess molecular topology that is very similar to their non-heavy atom substituted analogs of Formula I, since exchange of ¹³C for ¹²C is conformationally neutral and exchange of deuterium for hydrogen does not alter molecular shape. Deuterium replacement does cause a slight decrease in Van der Waals radius (Holtzer M E et. al., Biophys. J. 2001 80: 939; Wade D, Chem. Biol. Interact. 1999 117: 191), but applicant believes that such decrease will not significantly reduce binding affinity between the molecule and its receptor. Furthermore, the smaller size of the deuterated compounds prevents their being involved in new undesirable steric clashes with the binding protein relative to the unsubstituted compounds. Neither ¹³C, nor deuterium, atoms in the compounds of this invention contribute significantly to hydrogen bonding or ionic interactions with the protein receptors. This is because the majority of hydrogen bond and ionic interactions formed by the compound with the receptor are through the amine nitrogen and possibly the ether oxygen. Any deuterium atoms attached to the amine nitrogen will be rapidly exchanged with bulk solvent protons under physiological conditions. Protein reorganization will be identical between a compound of this invention and its corresponding non-deuterated, non-¹³C compounds. As discussed above, desolvation energy of a compound of this invention comprising deuterium is less than that of the corresponding non-deuterated, non-¹³C compound, thus increasing binding affinity for the receptor. Desolvation energy for a compound of this invention comprising ¹³C in place of ¹²C is essentially identical.

Thus, a compound of this invention advantageously retains substantial binding to the serotonin and norepinephrine uptake proteins and is an active inhibitor of serotonin and norepinephrine uptake.

### DETAILED DESCRIPTION OF THE INVENTION

The present invention relates to a compound of formula I: 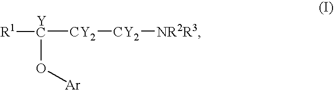
or a pharmaceutically acceptable acid addition salt thereof, wherein:
each Y is independently selected from H or deuterium;
R¹ is C₅-C₇ cycloalkyl, thienyl, halothienyl, (C₁-C₄ alkyl) thienyl, furanyl, pyridyl, thiazolyl;
Ar is 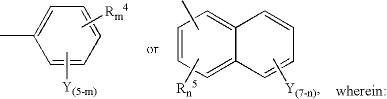
   each R⁴ is independently selected from halo, C₁-C₄ alkyl, C₁-C₃ alkoxy or trifluoromethyl;
   each R⁵ is independently selected from halo, C₁-C₄ alkyl or trifluo-romethyl;
   m is 0, 1 or 2; and
   n is 0 or 1;
each of R² and R³ is independently selected from hydrogen, deuterium or CY₃; and
each carbon atom is optionally replaced with ¹³C,
   wherein at least one Y is deuterium.

The term “C₁-C₄ alkyl” represents a straight or branched alkyl chain bearing from one to four carbon atoms. Typical C₁-C₄ alkyl groups include methyl, ethyl, n-propyl, isopropyl, n-butyl, isobutyl, sec-butyl and t-butyl.

The term “C₁-C₃ alkoxy” represents methoxy, ethoxy, n-propoxy or isopropoxy

The term “halo” represents fluoro, chloro, bromo or iodo.

When Ar is naphthalenyl, it can be either 1-naphthalenyl or 2-naphtheny. When R¹ is furanyl, it can be either 2-furanyl or 3-furanyl. When R¹ is pyridyl, it can be either 2-pyridyl, 3-pyridyl or 4-pyridyl. When R¹ is thiazoyl, it can be 2-thiazolyl, 4-thiazolyl or 4-thazolyl.

(C₁-C₄ alkyl)thienyl represents a thienyl ring mono substituted with a C₁ -C₄ alkyl substituent. Typical (C₁-C₄ alkyl)thienyl groups include 4-methyl-2-thienyl, 3-ethyl-2-thienyl, 2-methyl-3-thienyl, 4-propyl-3-thienyl, 5-n-butyl-2-thienyl, 4-methyl-3-thienyl, 3-methyl-2-thienyl, and the like.

Halothienyl represents a thienyl ring monosubstituted with a halo substituent. Typical halo-thienyl groups include 3-chloro-2-thienyl, 4-bromo-3-thienyl, 2-iodo-3-thienyl, 5-iodo-3-thienyl, 4-fluoro-2-thienyl, 2-bromo-3thienyl, 4-chloro-2-thienyl and the like.

Compounds of formula I wherein at least one Y in Ar, R² or R³ is deuterium are preferred. More preferred is a compound of formula I, wherein at least one Y at a position subject to oxidative metabolism in humans is deuterium. In the case of Compound A, these positions are disclosed Lantz R J , et. al., Drug Metab. Dispos. 2003 31:1142 and include carbons 4, 5, and 6 of the naphthalene ring, the N-methyl carbon, and the carbon bearing the secondary hydroxyl group. Yet more preferred is a compound wherein Ar is napthylenyl, and at least one Y in the 4, 5, or 6 position of said napthylenyl is deuterium.

According to another preferred embodiment, R¹ is halothienyl, (C₁-C₄ alkyl)thienyl, or thienyl. More preferably, R¹ is thienyl.

In another preferred embodiment, one of R² and R³ is selected from hydrogen or deuterium and the other is CY₃. Even more preferred is when one of R² and R³ is selected from hydrogen or deuterium, the other is CY₃ and each of the Y groups in CY₃ are deuterium.

In another preferred embodiment both R² and R³ are selected from hydrogen or deuterium. These latter compounds are preferred for inhibiting the uptake of norepineph-rine in mammals.

In another preferred embodiment both R² and R³ are CY₃. More preferably, at least one of R² or R³ is CD₃. Most preferably, at both of R² and R³ is CD₃. These compounds are very useful as intermediates in the synthesis of other compounds of Formula I.

The compounds of the present invention possess an asymmetric carbon. As such, the compounds can exist as the individual stereoisomers as well as the racemic mixture. Accordingly, the compounds of the present invention will include not only the dl-racemates, but also their respective optically active d- and 1-isomers substantially isolated from one another. A “substantially isolated” isomer is one that is predominantly one form relative to other stereoisomers in a combination of stereoisomers. In embodiments, the substantially isolated isomer comprises less than 25% of other stereoisomers, preferably less than 10% of other stereoisomers, more preferably less than 5% of other stereoisomers and most preferably less than 2% of other stereoisomers. Methods of isolating stereoisomers from each other are well known in the art.

In another preferred embodiment, a compound of the invention is a derivative of Compound A represented by Formula II: 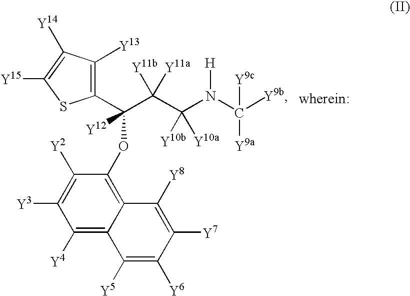
each Y is independently selected from H or deuterium;
the exchangeable proton attached to N is optionally replaced by deuterium;
at least one group Y is deuterium; and
one or more carbon atoms is optionally replaced with ¹³C.
   Throughout this specification, reference to “each Y” includes, independently, all “Y” groups including for example Y², Y³, Y⁴, Y⁵, Y⁶, Y⁷, Y⁸, Y⁹, Y^{9a}, Y^{9b, Y}^{9c}, Y¹⁰, Y^{10a}, Y^{10b}, Y¹¹, Y^{11a}, Y^{11b}, Y¹², Y¹³, Y¹⁴, Y¹⁵, Y¹⁶, Y^{16a}, Y^{16b}, Y^{16c}, where applicable.

More preferred compounds of Formula II are those represented, independently, by formulas III, IV, V, VI, VII, VIII, IX, X, XI, XII, XIII, and XIV. 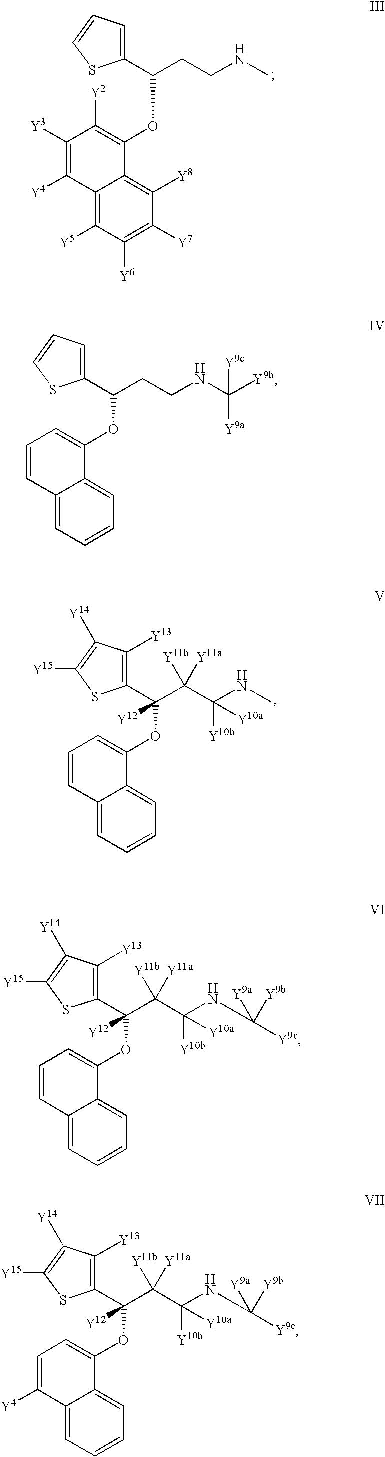 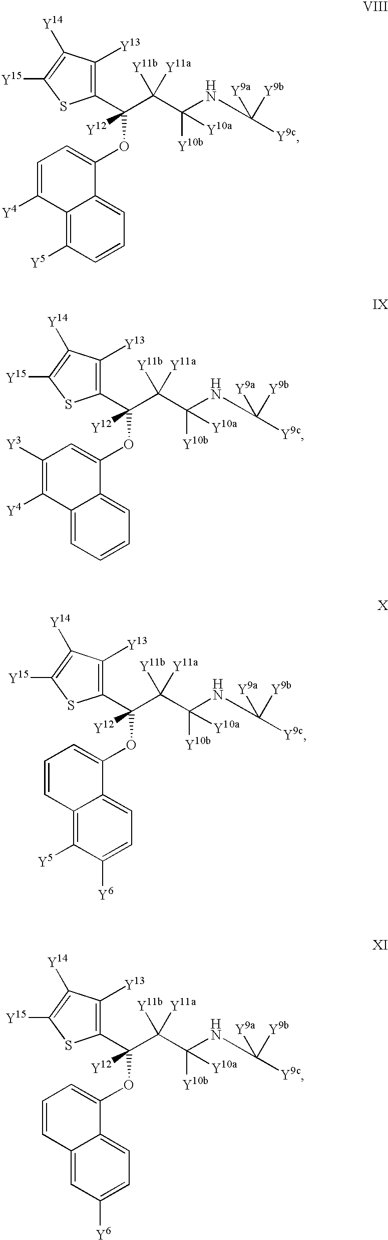 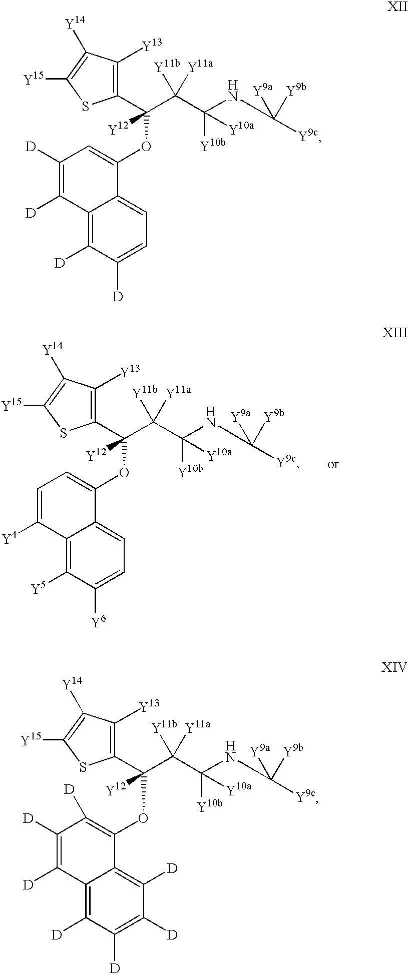
each Y is independently selected from H or deuterium; and wherein in each compound the exchangeable H shown attached to N is optionally replaced with deuterium; and one or more carbons are optionally replaced by with ¹³C. More preferred are compounds of formulae III, VII, VIII, IX, X, XI, XII, and XIII.

Preferred compounds of each of compounds of formulae III-XIV are set forth in the tables below. In those tables, D represents deuterium; the exchangeable H shown attached to N is optionally replaced by deuterium; and one or more carbons are optionally replaced by with ¹³C. An open position in the table is indicative of an “H” or hydrogen atom at that position in the compound.

Another aspect of the invention is a compound of any of the formulae herein for use in the treatment or prevention in a subject of a disease, disorder or symptom thereof delineated herein. Another aspect of the invention is use of a compound of any of the formulae herein in the manufacture of a medicament for treatment or prevention in a subject of a disease, disorder or symptom thereof delineated herein.

TABLE 1
Preferred Compounds of Formula III.

| Cmpd | Y² | Y³ | Y⁴ | Y⁵ | Y⁶ | Y⁷ | Y⁸ |
|---|---|---|---|---|---|---|---|
| 1 | | | D | | | | |
| 2 | | | D | D | | | |
| 3 | | | | D | | | |
| 4 | | | | | D | | |
| 5 | | | | D | D | | |
| 6 | | D | D | D | D | | |
| 7 | | | D | D | D | | |
| 8 | D | D | D | D | D | D | D |

TABLE 2
Preferred Compounds of Formula IV.

| Cmpd | Y^{9a} | Y^{9b} | Y^{9c} |
|---|---|---|---|
| 9 | D | | |
| 10 | D | D | |
| 11 | D | D | D |

TABLE 3
Preferred Compounds of Formula V.

| Cmpd | Y^{10a} | Y^{10b} | Y^{11a} | Y^{11b} | Y¹² | Y¹³ | Y¹⁴ | Y¹⁵ |
|---|---|---|---|---|---|---|---|---|
| 12 | D | | | | | | | |
| 13 | D | D | | | | | | |
| 14 | D | | D | | | | | |
| 15 | D | D | D | D | | | | |
| 16 | | | | | D | | | |
| 17 | | | | | | | | D |
| 18 | | | | | | D | D | D |

TABLE 4
Additional Preferred Compounds of Formula V.

| Cmpd | Y^{10a} | Y^{10b} | Y^{11a} | Y^{11b} | Y¹² | Y¹³ | Y¹⁴ | Y¹⁵ |
|---|---|---|---|---|---|---|---|---|
| 19 | D | | | | D | | | |
| 20 | D | | | | | | | D |
| 21 | D | | | | | D | D | D |
| 22 | D | D | | | D | | | |
| 23 | D | D | | | | | | D |
| 24 | D | D | | | | D | D | D |
| 25 | D | | D | | D | | | |
| 26 | D | | D | | | | | D |
| 27 | D | | D | | | D | D | D |
| 28 | D | D | D | D | D | | | |
| 29 | D | D | D | D | | | | D |
| 30 | D | D | D | D | | D | D | D |

TABLE 5
Preferred Compounds of Formula VI.

| Cmpd | Y^{9a} | Y^{9b} | Y^{9c} | Y^{10a} | Y^{10b} | Y^{11a} | Y^{11b} | Y¹² | Y¹³ | Y¹⁴ | Y¹⁵ |
|---|---|---|---|---|---|---|---|---|---|---|---|
| 31 | D | | | D | | | | | | | |
| 32 | D | | | D | D | | | | | | |
| 33 | D | | | D | | D | | | | | |
| 34 | D | | | D | D | D | D | | | | |
| 35 | D | | | | | | | D | | | |
| 36 | D | | | | | | | | | | D |
| 37 | D | | | | | | | | D | D | D |
| 38 | D | | | D | | | | D | | | |
| 39 | D | | | D | | | | | D | | |
| 40 | D | | | D | | | | | D | D | D |
| 41 | D | | | D | D | | | D | | | |
| 42 | D | | | D | D | | | | | | D |
| 43 | D | | | D | D | | | | D | D | D |
| 44 | D | | | D | | D | | D | | | |
| 45 | D | | | D | | D | | | | | D |
| 46 | D | | | D | | D | | | D | D | D |
| 47 | D | | | D | D | D | D | D | | | |
| 48 | D | | | D | D | D | D | | | | D |
| 49 | D | | | D | D | D | D | | D | D | D |
| 50 | D | D | | D | | | | | | | |
| 51 | D | D | | D | D | | | | | | |
| 52 | D | D | | D | | D | | | | | |
| 53 | D | D | | D | D | D | D | | | | |
| 54 | D | D | | | | | | D | | | |
| 55 | D | D | | | | | | | | | D |
| 56 | D | D | | | | | | | D | D | D |
| 57 | D | D | | D | | | | D | | | |
| 58 | D | D | | D | | | | | | | D |
| 59 | D | D | | D | | | | | D | D | D |
| 60 | D | D | | D | D | | | D | | | |
| 61 | D | D | | D | D | | | | | | D |
| 62 | D | D | | D | D | | | | D | D | D |
| 63 | D | D | | D | | D | | D | | | |
| 64 | D | D | | D | | D | | | | | D |
| 65 | D | D | | D | | D | | | D | D | D |
| 66 | D | D | | D | D | D | D | D | | | |
| 67 | D | D | | D | D | D | D | | | | D |
| 68 | D | D | | D | D | D | D | | D | D | D |
| 69 | D | D | D | D | | | | | | | |
| 70 | D | D | D | D | D | | | | | | |
| 71 | D | D | D | D | | D | | | | | |
| 72 | D | D | D | D | D | D | D | | | | |
| 73 | D | D | D | | | | | D | | | |
| 74 | D | D | D | | | | | | | | D |
| 75 | D | D | D | | | | | | D | D | D |
| 76 | D | D | D | D | | | | D | | | |
| 77 | D | D | D | D | | | | | | | D |
| 78 | D | D | D | D | | | | | D | D | D |
| 79 | D | D | D | D | D | | | D | | | |
| 80 | D | D | D | D | D | | | | | | D |
| 81 | D | D | D | D | D | | | | D | D | D |
| 82 | D | D | D | D | | D | | D | | | |
| 83 | D | D | D | D | | D | | | | | D |
| 84 | D | D | D | D | | D | | | D | D | D |
| 85 | D | D | D | D | D | D | D | D | | | |
| 86 | D | D | D | D | D | D | D | | | | D |
| 87 | D | D | D | D | D | D | D | | D | D | D |

TABLE 6
Preferred Compounds of Formula VII.

| Cmpd | Y⁴ | Y^{9a} | Y^{9b} | Y^{9c} | Y^{10a} | Y^{10b} | Y^{11a} | Y^{11b} | Y¹² | Y¹³ | Y¹⁴ | Y¹⁵ |
|---|---|---|---|---|---|---|---|---|---|---|---|---|
| 88 | D | D | | | | | | | | | | |
| 89 | D | D | D | | | | | | | | | |
| 90 | D | D | D | D | | | | | | | | |
| 91 | D | | | | D | | | | | | | |
| 92 | D | | | | D | D | | | | | | |
| 93 | D | | | | D | | D | | | | | |
| 94 | D | | | | D | D | D | D | | | | |
| 95 | D | | | | | | | | D | | | |
| 96 | D | | | | | | | | | | | D |
| 97 | D | | | | | | | | | D | D | D |
| 98 | D | | | | D | | | | D | | | |
| 99 | D | | | | D | | | | | | | D |
| 100 | D | | | | D | | | | | D | D | D |
| 101 | D | | | | D | D | | | D | | | |
| 102 | D | | | | D | D | | | | | | D |
| 103 | D | | | | D | D | | | | D | D | D |
| 104 | D | | | | D | | D | | D | | | |
| 105 | D | | | | D | | D | | | | | D |
| 106 | D | | | | D | | D | | | D | D | D |
| 107 | D | | | | D | D | D | D | D | | | |
| 108 | D | | | | D | D | D | D | | | | D |
| 109 | D | | | | D | D | D | D | | D | D | D |
| 110 | D | D | | | D | | | | | | | |
| 111 | D | D | | | D | D | | | | | | |
| 112 | D | D | | | D | | D | | | | | |
| 113 | D | D | | | D | D | D | D | | | | |
| 114 | D | D | | | | | | | D | | | |
| 115 | D | D | | | | | | | | | | D |
| 116 | D | D | | | | | | | | D | D | D |
| 117 | D | D | | | D | | | | D | | | |
| 118 | D | D | | | D | | | | | | | D |
| 119 | D | D | | | D | | | | | D | D | D |
| 120 | D | D | | | D | D | | | D | | | |
| 121 | D | D | | | D | D | | | | | | D |
| 122 | D | D | | | D | D | | | | D | D | D |
| 123 | D | D | | | D | | D | | D | | | |
| 124 | D | D | | | D | | D | | | | | D |
| 125 | D | D | | | D | | D | | | D | D | D |
| 126 | D | D | | | D | D | D | D | D | | | |
| 127 | D | D | | | D | D | D | D | | | | D |
| 128 | D | D | | | D | D | D | D | | D | D | D |
| 129 | D | D | D | | D | | | | | | | |
| 130 | D | D | D | | D | D | | | | | | |
| 131 | D | D | D | | D | | D | | | | | |
| 132 | D | D | D | | D | D | D | D | | | | |
| 133 | D | D | D | | | | | | D | | | |
| 134 | D | D | D | | | | | | | | | D |
| 135 | D | D | D | | | | | | | D | D | D |
| 136 | D | D | D | | D | | | | D | | | |
| 137 | D | D | D | | D | | | | | | | |
| 138 | D | D | D | | D | | | | | D | D | D |
| 139 | D | D | D | | D | D | | | D | | | |
| 140 | D | D | D | | D | D | | | | | | D |
| 141 | D | D | D | | D | D | | | | D | D | D |
| 142 | D | D | D | | D | | D | | D | | | |
| 143 | D | D | D | | D | | D | | | | | D |
| 144 | D | D | D | | D | | D | | | D | D | D |
| 145 | D | D | D | | D | D | D | D | D | | | |
| 146 | D | D | D | | D | D | D | D | | | | D |
| 147 | D | D | D | | D | D | D | D | | D | D | D |
| 148 | D | D | D | D | D | | | | | | | |
| 149 | D | D | D | D | D | D | | | | | | |
| 150 | D | D | D | D | D | | D | | | | | |
| 151 | D | D | D | D | D | D | D | D | D | | | |
| 152 | D | D | D | D | | | | | D | | | |
| 153 | D | D | D | D | | | | | | | | D |
| 154 | D | D | D | D | | | | | | D | D | D |
| 155 | D | D | D | D | D | | | | D | | | |
| 156 | D | D | D | D | D | | | | | | | D |
| 157 | D | D | D | D | D | | | | | D | D | D |
| 158 | D | D | D | D | D | D | | | D | | | |
| 159 | D | D | D | D | D | D | | | | | | D |
| 160 | D | D | D | D | D | D | | | | D | D | D |
| 161 | D | D | D | D | D | | D | | D | | | |
| 162 | D | D | D | D | D | | D | | | | | D |
| 163 | D | D | D | D | D | | D | | | D | D | D |
| 164 | D | D | D | D | D | D | D | D | D | | | |
| 165 | D | D | D | D | D | D | D | D | | | | D |
| 166 | D | D | D | D | D | D | D | D | | D | D | D |

TABLE 7
Preferred Compounds of Formula VIII.

| Cmpd | Y⁴ | Y⁵ | Y^{9a} | Y^{9b} | Y^{9c} | Y^{10a} | Y^{10b} | Y^{11a} | Y^{11b} | Y¹² | Y¹³ | Y¹⁴ | Y¹⁵ |
|---|---|---|---|---|---|---|---|---|---|---|---|---|---|
| 167 | D | D | D | | | | | | | | | | |
| 168 | D | D | D | D | | | | | | | | | |
| 169 | D | D | D | D | D | | | | | | | | |
| 170 | D | D | | | | D | | | | | | | |
| 171 | D | D | | | | D | D | | | | | | |
| 172 | D | D | | | | D | | D | | | | | |
| 173 | D | D | | | | D | D | D | D | | | | |
| 174 | D | D | | | | | | | | D | | | |
| 175 | D | D | | | | | | | | | | | D |
| 176 | D | D | | | | | | | | | D | D | D |
| 177 | D | D | | | | D | | | | D | | | |
| 178 | D | D | | | | D | | | | | | | D |
| 179 | D | D | | | | D | | | | | D | D | D |
| 180 | D | D | | | | D | D | | | D | | | |
| 181 | D | D | | | | D | D | | | | | | D |
| 182 | D | D | | | | D | D | | | | D | D | D |
| 183 | D | D | | | | D | | D | | D | | | |
| 184 | D | D | | | | D | | D | | | | | D |
| 185 | D | D | | | | D | | D | | | D | D | D |
| 186 | D | D | | | | D | D | D | D | D | | | |
| 187 | D | D | | | | D | D | D | D | | | | D |
| 188 | D | D | | | | D | D | D | D | | D | D | D |
| 189 | D | D | D | | | D | | | | | | | |
| 190 | D | D | D | | | D | D | | | | | | |
| 191 | D | D | D | | | D | | D | | | | | |
| 192 | D | D | D | | | D | D | D | D | | | | |
| 193 | D | D | D | | | | | | | D | | | |
| 194 | D | D | D | | | | | | | | | | D |
| 195 | D | D | D | | | | | | | | D | D | D |
| 196 | D | D | D | | | D | | | | D | | | |
| 197 | D | D | D | | | D | | | | | | | D |
| 198 | D | D | D | | | D | | | | | D | D | D |
| 199 | D | D | D | | | D | D | | | D | | | |
| 200 | D | D | D | | | D | D | | | | | | D |
| 201 | D | D | D | | | D | D | | | | D | D | D |
| 202 | D | D | D | | | D | | D | | D | | | |
| 203 | D | D | D | | | D | | D | | | | | D |
| 204 | D | D | D | | | D | | D | | | D | D | D |
| 205 | D | D | D | | | D | D | D | D | D | | | |
| 206 | D | D | D | | | D | D | D | D | | | | D |
| 207 | D | D | D | | | D | D | D | D | | D | D | D |
| 208 | D | D | D | D | | D | | | | | | | |
| 209 | D | D | D | D | | D | D | | | | | | |
| 210 | D | D | D | D | | D | | D | | | | | |
| 211 | D | D | D | D | | D | D | D | D | | | | |
| 212 | D | D | D | D | | | | | | D | | | |
| 213 | D | D | D | D | | | | | | | | | D |
| 214 | D | D | D | D | | | | | | | D | D | D |
| 215 | D | D | D | D | | D | | | | D | | | |
| 216 | D | D | D | D | | D | | | | | | | D |
| 217 | D | D | D | D | | D | | | | | D | D | D |
| 218 | D | D | D | D | | D | D | | | D | | | |
| 219 | D | D | D | D | | D | D | | | | | | D |
| 220 | D | D | D | D | | D | D | | | | D | D | D |
| 221 | D | D | D | D | | D | | D | | D | | | |
| 222 | D | D | D | D | | D | | D | | | | | D |
| 223 | D | D | D | D | | D | | D | | | D | D | D |
| 224 | D | D | D | D | | D | D | D | D | D | | | |
| 225 | D | D | D | D | | D | D | D | D | | | | D |
| 226 | D | D | D | D | | D | D | D | D | | D | D | D |
| 227 | D | D | D | D | D | D | | | | | | | |
| 228 | D | D | D | D | D | D | D | | | | | | |
| 229 | D | D | D | D | D | D | | D | | | | | |
| 230 | D | D | D | D | D | D | D | D | D | | | | |
| 231 | D | D | D | D | D | | | | | D | | | |
| 232 | D | D | D | D | D | | | | | | | | D |
| 233 | D | D | D | D | D | | | | | | D | D | D |
| 234 | D | D | D | D | D | D | | | | D | | | |
| 235 | D | D | D | D | D | D | | | | | | | D |
| 236 | D | D | D | D | D | D | | | | | D | D | D |
| 237 | D | D | D | D | D | D | D | | | D | | | |
| 238 | D | D | D | D | D | D | D | | | | | | D |
| 239 | D | D | D | D | D | D | D | | | | D | D | D |
| 240 | D | D | D | D | D | D | | D | | D | | | |
| 241 | D | D | D | D | D | D | | D | | | | | D |
| 242 | D | D | D | D | D | D | | D | | | D | D | D |
| 243 | D | D | D | D | D | D | D | D | D | D | | | |
| 244 | D | D | D | D | D | D | D | D | D | | | | D |
| 245 | D | D | D | D | D | D | D | D | | | D | D | D |

TABLE 8
Preferred Compounds of Formula IX.

| Cmpd | Y³ | Y⁴ | Y^{9a} | Y^{9b} | Y^{9c} | Y^{10a} | Y^{10b} | Y^{11a} | Y^{11b} | Y¹² | Y¹³ | Y¹⁴ | Y¹⁵ |
|---|---|---|---|---|---|---|---|---|---|---|---|---|---|
| 246 | D | D | | | | | | | | | | | |
| 247 | D | D | D | | | | | | | | | | |
| 248 | D | D | D | D | | | | | | | | | |
| 249 | D | D | | | D | | | | | | | | |
| 250 | D | D | | | D | D | | | | | | | |
| 251 | D | D | | | D | | D | | | | | | |
| 252 | D | D | | | D | D | D | D | | | | | |
| 253 | D | D | | | | | | | D | | | | |
| 254 | D | D | | | | | | | | | | D | |
| 255 | D | D | | | | | | | | D | D | D | |
| 256 | D | D | | | D | | | | D | | | | |
| 257 | D | D | | | D | | | | | | | D | |
| 258 | D | D | | | D | | | | | D | D | D | |
| 259 | D | D | | | D | D | | | D | | | | |
| 260 | D | D | | | D | D | | | | | | D | |
| 261 | D | D | | | D | D | | | | D | D | D | |
| 262 | D | D | | | D | | D | | D | | | | |
| 263 | D | D | | | D | | D | | | | | D | |
| 264 | D | D | | | D | | D | | | D | D | D | |
| 265 | D | D | | | D | D | D | D | D | | | | |
| 266 | D | D | | | D | D | D | D | | | | D | |
| 267 | D | D | | | D | D | D | D | | D | D | D | |
| 268 | D | D | | | D | | | | | | | | |
| 269 | D | D | | | D | D | | | | | | | |
| 270 | D | D | | | D | | D | | | | | | |
| 271 | D | D | | | D | D | D | D | | | | | |
| 272 | D | D | | | | | | | D | | | | |
| 273 | D | D | | | | | | | | | | D | |
| 274 | D | D | | | | | | | | D | D | D | |
| 275 | D | D | | | D | | | | D | | | | |
| 276 | D | D | | | D | | | | | | | | |
| 277 | D | D | | | D | | | | | D | D | D | |
| 278 | D | D | | | D | D | | | D | | | | |
| 279 | D | D | | | D | D | | | | | | D | |
| 280 | D | D | | | D | D | | | | D | D | D | |
| 281 | D | D | | | D | | D | | D | | | | |
| 282 | D | D | | | D | | D | | | | | D | |
| 283 | D | D | | | D | | D | | | D | D | D | |
| 284 | D | D | | | D | D | D | D | D | | | | |
| 285 | D | D | | | D | D | D | D | | | | D | |
| 286 | D | D | | | D | D | D | D | | D | D | D | |
| 287 | D | D | D | | D | | | | | | | | |
| 288 | D | D | D | | D | D | | | | | | | |
| 289 | D | D | D | | D | | D | | | | | | |
| 290 | D | D | D | | D | D | D | D | | | | | |
| 291 | D | D | D | | | | | | D | | | | |
| 292 | D | D | D | | | | | | | | | D | |
| 293 | D | D | D | | | | | | | D | D | D | |
| 294 | D | D | D | | D | | | | D | | | | |
| 295 | D | D | D | | D | | | | | D | | | |
| 296 | D | D | D | | D | | | | | D | D | D | |
| 297 | D | D | D | | D | D | | | D | | | | |
| 298 | D | D | D | | D | D | | | | | | D | |
| 299 | D | D | D | | D | D | | | | D | D | D | |
| 300 | D | D | D | | D | | D | | D | | | | |
| 301 | D | D | D | | D | | D | | | D | | | |
| 302 | D | D | D | | D | | D | | | D | D | D | |
| 303 | D | D | D | | D | D | D | D | D | | | | |
| 304 | D | D | D | | D | D | D | D | | | | D | |
| 305 | D | D | D | | D | D | D | D | | D | D | D | |
| 306 | D | D | D | D | D | | | | | | | | |
| 307 | D | D | D | D | D | D | | | | | | | |
| 308 | D | D | D | D | D | | D | | | | | | |
| 309 | D | D | D | D | D | D | D | D | | | | | |
| 310 | D | D | D | D | | | | | D | | | | |
| 311 | D | D | D | D | | | | | | | | D | |
| 312 | D | D | D | D | | | | | | D | D | D | |
| 313 | D | D | D | D | D | | | | D | | | | |
| 314 | D | D | D | D | D | | | | | | | D | |
| 315 | D | D | D | D | D | | | | | D | D | D | |
| 316 | D | D | D | D | D | D | | | D | | | | |
| 317 | D | D | D | D | D | D | | | | | | D | |
| 318 | D | D | D | D | D | D | | | | D | D | D | |
| 319 | D | D | D | D | D | | D | | D | | | | |
| 320 | D | D | D | D | D | | D | | | | | D | |
| 321 | D | D | D | D | D | | D | | | D | D | D | |
| 322 | D | D | D | D | D | D | D | D | D | | | | |
| 323 | D | D | D | D | D | D | D | D | | | | D | |
| 324 | D | D | D | D | D | D | D | D | | D | D | D | |

TABLE 9
Preferred Compounds of Formula X.

| Cmpd | Y⁵ | Y⁶ | Y^{9a} | Y^{9b} | Y^{9c} | Y^{10a} | Y^{10b} | Y^{11a} | Y^{11b} | Y¹² | Y¹³ | Y¹⁴ | Y¹⁵ |
|---|---|---|---|---|---|---|---|---|---|---|---|---|---|
| 325 | D | D | D | | | | | | | | | | |
| 326 | D | D | D | D | | | | | | | | | |
| 327 | D | D | D | D | D | | | | | | | | |
| 328 | D | D | | | | D | | | | | | | |
| 329 | D | D | | | | D | D | | | | | | |
| 330 | D | D | | | | D | | D | | | | | |
| 331 | D | D | | | | D | D | D | D | | | | |
| 332 | D | D | | | | | | | | D | | | |
| 333 | D | D | | | | | | | | | | | D |
| 334 | D | D | | | | | | | | | D | D | D |
| 335 | D | D | | | | D | | | | D | | | |
| 336 | D | D | | | | D | | | | | | | D |
| 337 | D | D | | | | D | | | | | D | D | D |
| 338 | D | D | | | | D | D | | | D | | | |
| 339 | D | D | | | | D | D | | | | | | D |
| 340 | D | D | | | | D | D | | | | D | D | D |
| 341 | D | D | | | | D | | D | | D | | | |
| 342 | D | D | | | | D | | D | | | | | D |
| 343 | D | D | | | | D | | D | | | D | D | D |
| 344 | D | D | | | | D | D | D | D | D | | | |
| 345 | D | D | | | | D | D | D | D | | | | D |
| 346 | D | D | | | | D | D | D | D | | D | D | D |
| 347 | D | D | D | | | D | | | | | | | |
| 348 | D | D | D | | | D | D | | | | | | |
| 349 | D | D | D | | | D | | D | | | | | |
| 350 | D | D | D | | | D | D | D | D | | | | |
| 351 | D | D | D | | | | | | | D | | | |
| 352 | D | D | D | | | | | | | | | | D |
| 353 | D | D | D | | | | | | | | D | D | D |
| 354 | D | D | D | | | D | | | | D | | | |
| 355 | D | D | D | | | D | | | | | | | D |
| 356 | D | D | D | | | D | | | | | D | D | D |
| 357 | D | D | D | | | D | D | | | D | | | |
| 358 | D | D | D | | | D | D | | | | | | D |
| 359 | D | D | D | | | D | D | | | | D | D | D |
| 360 | D | D | D | | | D | | D | | D | | | |
| 361 | D | D | D | | | D | | D | | | | | D |
| 362 | D | D | D | | | D | | D | | | D | D | D |
| 363 | D | D | D | | | D | D | D | D | D | | | |
| 364 | D | D | D | | | D | D | D | D | | | | D |
| 365 | D | D | D | | | D | D | D | D | | D | D | D |
| 366 | D | D | D | D | | D | | | | | | | |
| 367 | D | D | D | D | | D | D | | | | | | |
| 368 | D | D | D | D | | D | | D | | | | | |
| 369 | D | D | D | D | | D | D | D | D | | | | |
| 370 | D | D | D | D | | | | | | D | | | |
| 371 | D | D | D | D | | | | | | | | | D |
| 372 | D | D | D | D | | | | | | | D | D | D |
| 373 | D | D | D | D | | D | | | | D | | | |
| 374 | D | D | D | D | | D | | | | | | | D |
| 375 | D | D | D | D | | D | | | | | D | D | D |
| 376 | D | D | D | D | | D | D | | | D | | | |
| 377 | D | D | D | D | | D | D | | | | | | D |
| 378 | D | D | D | D | | D | D | | | | D | D | D |
| 379 | D | D | D | D | | D | | D | | D | | | |
| 380 | D | D | D | D | | D | | D | | | | | D |
| 381 | D | D | D | D | | D | | D | | | D | D | D |
| 382 | D | D | D | D | | D | D | D | D | D | | | |
| 383 | D | D | D | D | | D | D | D | D | | | | D |
| 384 | D | D | D | D | | D | D | D | D | | D | D | D |
| 385 | D | D | D | D | D | D | | | | | | | |
| 386 | D | D | D | D | D | D | D | | | | | | |
| 387 | D | D | D | D | D | D | | D | | | | | |
| 388 | D | D | D | D | D | D | D | D | D | | | | |
| 389 | D | D | D | D | D | | | | | D | | | |
| 390 | D | D | D | D | D | | | | | | | | D |
| 391 | D | D | D | D | D | | | | | | D | D | D |
| 392 | D | D | D | D | D | D | | | | D | | | |
| 393 | D | D | D | D | D | D | | | | | | | D |
| 394 | D | D | D | D | D | D | | | | | D | D | D |
| 395 | D | D | D | D | D | D | D | | | D | | | |
| 396 | D | D | D | D | D | D | D | | | | | | D |
| 397 | D | D | D | D | D | D | D | | | | D | D | D |
| 398 | D | D | D | D | D | D | | D | | D | | | |
| 399 | D | D | D | D | D | D | | D | | | | | D |
| 400 | D | D | D | D | D | D | | D | | | D | D | D |
| 401 | D | D | D | D | D | D | D | D | D | D | | | |
| 402 | D | D | D | D | D | D | D | D | D | | | | D |
| 403 | D | D | D | D | D | D | D | D | D | | D | D | D |

TABLE 10
Preferred Compounds of Formula XI.

| Cmpd | Y⁶ | Y^{9a} | Y^{9b} | Y^{9c} | Y^{10a} | Y^{10b} | Y^{11a} | Y^{11b} | Y¹² | Y¹³ | Y¹⁴ | Y¹⁵ |
|---|---|---|---|---|---|---|---|---|---|---|---|---|
| 404 | D | D | | | | | | | | | | |
| 405 | D | D | D | | | | | | | | | |
| 406 | D | D | D | D | | | | | | | | |
| 407 | D | | | | D | | | | | | | |
| 408 | D | | | | D | D | | | | | | |
| 409 | D | | | | D | | D | | | | | |
| 410 | D | | | | D | D | D | D | | | | |
| 411 | D | | | | | | | | D | | | |
| 412 | D | | | | | | | | | | | D |
| 413 | D | | | | | | | | | D | D | D |
| 414 | D | | | | D | | | | D | | | |
| 415 | D | | | | D | | | | | | | D |
| 416 | D | | | | D | | | | | D | D | D |
| 417 | D | | | | D | D | | | D | | | |
| 418 | D | | | | D | D | | | | | | D |
| 419 | D | | | | D | D | | | | D | D | D |
| 420 | D | | | | D | | D | | D | | | |
| 421 | D | | | | D | | D | | | | | D |
| 422 | D | | | | D | | D | | | D | D | D |
| 423 | D | | | | D | D | D | D | D | | | |
| 424 | D | | | | D | D | D | D | | | | D |
| 425 | D | | | | D | D | D | D | | D | D | D |
| 426 | D | D | | | D | | | | | | | |
| 427 | D | D | | | D | D | | | | | | |
| 428 | D | D | | | D | | D | | | | | |
| 429 | D | D | | | D | D | D | D | | | | |
| 430 | D | D | | | | | | | D | | | |
| 431 | D | D | | | | | | | | | | D |
| 432 | D | D | | | | | | | | D | D | D |
| 433 | D | D | | | D | | | | D | | | |
| 434 | D | D | | | D | | | | | | | D |
| 435 | D | D | | | D | | | | | D | D | D |
| 436 | D | D | | | D | D | | | D | | | |
| 437 | D | D | | | D | D | | | | | | D |
| 438 | D | D | | | D | D | | | | D | D | D |
| 439 | D | D | | | D | | D | | D | | | |
| 440 | D | D | | | D | | D | | | | | D |
| 441 | D | D | | | D | | D | | | D | D | D |
| 442 | D | D | | | D | D | D | D | D | | | |
| 443 | D | D | | | D | D | D | D | | | | D |
| 444 | D | D | | | D | D | D | D | | D | D | D |
| 445 | D | D | D | | D | | | | | | | |
| 446 | D | D | D | | D | D | | | | | | |
| 447 | D | D | D | | D | | D | | | | | |
| 448 | D | D | D | | D | D | D | D | | | | |
| 449 | D | D | D | | | | | | D | | | |
| 450 | D | D | D | | | | | | | | | D |
| 451 | D | D | D | | | | | | | D | D | D |
| 452 | D | D | D | | D | | | | D | | | |
| 453 | D | D | D | | D | | | | | | | D |
| 454 | D | D | D | | D | | | | | D | D | D |
| 455 | D | D | D | | D | D | | | D | | | |
| 456 | D | D | D | | D | D | | | | | | D |
| 457 | D | D | D | | D | D | | | | D | D | D |
| 458 | D | D | D | | D | | D | | D | | | |
| 459 | D | D | D | | D | | D | | | | | D |
| 460 | D | D | D | | D | | D | | | D | D | D |
| 461 | D | D | D | | D | D | D | D | D | | | |
| 462 | D | D | D | | D | D | D | D | | | | D |
| 463 | D | D | D | | D | D | D | D | | D | D | D |
| 464 | D | D | D | D | D | | | | | | | |
| 465 | D | D | D | D | D | D | | | | | | |
| 466 | D | D | D | D | D | | D | | | | | |
| 467 | D | D | D | D | D | D | D | D | | | | |
| 468 | D | D | D | D | | | | | D | | | |
| 469 | D | D | D | D | | | | | | | | D |
| 470 | D | D | D | D | | | | | | D | D | D |
| 471 | D | D | D | D | D | | | | D | | | |
| 472 | D | D | D | D | D | | | | | | | D |
| 473 | D | D | D | D | D | | | | | D | D | D |
| 474 | D | D | D | D | D | D | | | D | | | |
| 475 | D | D | D | D | D | D | | | | | | D |
| 476 | D | D | D | D | D | D | | | | D | D | D |
| 477 | D | D | D | D | D | | D | | D | | | |
| 478 | D | D | D | D | D | | D | | | | | D |
| 479 | D | D | D | D | D | | D | | | D | D | D |
| 480 | D | D | D | D | D | D | D | D | D | | | |
| 481 | D | D | D | D | D | D | D | D | | | | D |
| 482 | D | D | D | D | D | D | D | D | | D | D | D |

TABLE 11
Preferred Compounds of Formula XII.

| Cmpd | Y^{9a} | Y^{9b} | Y^{9c} | Y^{10a} | Y^{10b} | Y^{11a} | Y^{11b} | Y¹² | Y¹³ | Y¹⁴ | Y¹⁵ |
|---|---|---|---|---|---|---|---|---|---|---|---|
| 483 | D | | | | | | | | | | |
| 484 | D | D | | | | | | | | | |
| 485 | D | D | D | | | | | | | | |
| 486 | | | | D | | | | | | | |
| 487 | | | | D | D | | | | | | |
| 488 | | | | D | | D | | | | | |
| 489 | | | | D | D | D | D | | | | |
| 490 | | | | | | | | D | | | |
| 491 | | | | | | | | | | | D |
| 492 | | | | | | | | | D | D | D |
| 493 | | | | D | | | | D | | | |
| 494 | | | | D | | | | | | | D |
| 495 | | | | D | | | | | D | D | D |
| 496 | | | | D | D | | | D | | | |
| 497 | | | | D | D | | | | | | D |
| 498 | | | | D | D | | | | D | D | D |
| 499 | | | | D | | D | | D | | | |
| 500 | | | | D | | D | | | | | D |
| 501 | | | | D | | D | | | D | D | D |
| 502 | | | | D | D | D | D | D | | | |
| 503 | | | | D | D | D | D | | | | D |
| 504 | | | | D | D | D | D | | D | D | D |
| 505 | D | | | D | | | | | | | |
| 506 | D | | | D | D | | | | | | |
| 507 | D | | | D | | D | | | | | |
| 508 | D | | | D | D | D | D | | | | |
| 509 | D | | | | | | | D | | | |
| 510 | D | | | | | | | | | | D |
| 511 | D | | | | | | | | D | D | D |
| 512 | D | | | D | | | | D | | | |
| 513 | D | | | D | | | | | | | D |
| 514 | D | | | D | | | | | D | D | D |
| 515 | D | | | D | D | | | D | | | |
| 516 | D | | | D | D | | | | | | D |
| 517 | D | | | D | D | | | | D | D | D |
| 518 | D | | | D | | D | | D | | | |
| 519 | D | | | D | | D | | | | | D |
| 520 | D | | | D | | D | | | D | D | D |
| 521 | D | | | D | D | D | D | D | | | |
| 522 | D | | | D | D | D | D | | | | D |
| 523 | D | | | D | D | D | D | | D | D | D |
| 524 | D | D | | D | | | | | | | |
| 525 | D | D | | D | D | | | | | | |
| 526 | D | D | | D | | D | | | | | |
| 527 | D | D | | D | D | D | D | | | | |
| 528 | D | D | | | | | | D | | | |
| 529 | D | D | | | | | | | | | D |
| 530 | D | D | | | | | | | D | D | D |
| 531 | D | D | | D | | | | D | | | |
| 532 | D | D | | D | | | | | | | D |
| 533 | D | D | | D | | | | | D | D | D |
| 534 | D | D | | D | D | | | D | | | |
| 535 | D | D | | D | D | | | | | | D |
| 536 | D | D | | D | D | | | | D | D | D |
| 537 | D | D | | D | | D | | D | | | |
| 538 | D | D | | D | | D | | | | | D |
| 539 | D | D | | D | | D | | | D | D | D |
| 540 | D | D | | D | D | D | D | D | | | |
| 541 | D | D | | D | D | D | D | | | | D |
| 542 | D | D | | D | D | D | D | | D | D | D |
| 543 | D | D | D | D | | | | | | | |
| 544 | D | D | D | D | D | | | | | | |
| 545 | D | D | D | D | | D | | | | | |
| 546 | D | D | D | D | D | D | D | | | | |
| 547 | D | D | D | | | | | D | | | |
| 548 | D | D | D | | | | | | | | D |
| 549 | D | D | D | | | | | | D | D | D |
| 550 | D | D | D | D | | | | D | | | |
| 551 | D | D | D | D | | | | | | | D |
| 552 | D | D | D | D | | | | | D | D | D |
| 553 | D | D | D | D | D | | | D | | | |
| 554 | D | D | D | D | D | | | | | | D |
| 555 | D | D | D | D | D | | | | D | D | D |
| 556 | D | D | D | D | | D | | D | | | |
| 557 | D | D | D | D | | D | | | | | D |
| 558 | D | D | D | D | | D | | | D | D | D |
| 559 | D | D | D | D | D | D | D | D | | | |
| 560 | D | D | D | D | D | D | D | | | | D |
| 561 | D | D | D | D | D | D | D | | D | D | D |

TABLE 12
Preferred Compounds of Formula XIII.

| Cmpd | Y⁴ | Y⁵ | Y⁶ | Y^{9a} | Y^{9b} | Y^{9c} | Y^{10a} | Y^{10b} | Y^{11a} | Y^{11b} | Y¹² | Y¹³ | Y¹⁴ | Y¹⁵ |
|---|---|---|---|---|---|---|---|---|---|---|---|---|---|---|
| 562 | D | D | D | D | | | | | | | | | | |
| 563 | D | D | D | D | D | | | | | | | | | |
| 564 | D | D | D | D | D | D | | | | | | | | |
| 565 | D | D | D | | | | D | | | | | | | |
| 566 | D | D | D | | | | D | D | | | | | | |
| 567 | D | D | D | | | | D | | D | | | | | |
| 568 | D | D | D | | | | D | D | D | D | | | | |
| 569 | D | D | D | | | | | | | | D | | | |
| 570 | D | D | D | | | | | | | | | | | D |
| 571 | D | D | D | | | | | | | | | D | D | D |
| 572 | D | D | D | | | | D | | | | D | | | |
| 573 | D | D | D | | | | D | | | | | | | D |
| 574 | D | D | D | | | | D | | | | | D | D | D |
| 575 | D | D | D | | | | D | D | | | D | | | |
| 576 | D | D | D | | | | D | D | | | | | | D |
| 577 | D | D | D | | | | D | D | | | | D | D | D |
| 578 | D | D | D | | | | D | | D | | D | | | |
| 579 | D | D | D | | | | D | | D | | | | | D |
| 580 | D | D | D | | | | D | | D | | | D | D | D |
| 581 | D | D | D | | | | D | D | D | D | D | | | |
| 582 | D | D | D | | | | D | D | D | D | | | | D |
| 583 | D | D | D | | | | D | D | D | D | | D | D | D |
| 584 | D | D | D | D | | | D | | | | | | | |
| 585 | D | D | D | D | | | D | D | | | | | | |
| 586 | D | D | D | D | | | D | | D | | | | | |
| 587 | D | D | D | D | | | D | D | D | D | | | | |
| 588 | D | D | D | D | | | | | | | D | | | |
| 589 | D | D | D | D | | | | | | | | | | D |
| 590 | D | D | D | D | | | | | | | | D | D | D |
| 591 | D | D | D | D | | | D | | | | D | | | |
| 592 | D | D | D | D | | | D | | | | | | | D |
| 593 | D | D | D | D | | | D | | | | | D | D | D |
| 594 | D | D | D | D | | | D | D | | | D | | | |
| 595 | D | D | D | D | | | D | D | | | | | | D |
| 596 | D | D | D | D | | | D | D | | | | D | D | D |
| 597 | D | D | D | D | | | D | | D | | D | | | |
| 598 | D | D | D | D | | | D | | D | | | | | D |
| 599 | D | D | D | D | | | D | | D | | | D | D | D |
| 600 | D | D | D | D | | | D | D | D | D | D | | | |
| 601 | D | D | D | D | | | D | D | D | D | | | | D |
| 602 | D | D | D | D | | | D | D | D | D | | D | D | D |
| 603 | D | D | D | D | D | | D | | | | | | | |
| 604 | D | D | D | D | D | | D | D | | | | | | |
| 605 | D | D | D | D | D | | D | | D | | | | | |
| 606 | D | D | D | D | D | | D | D | D | D | | | | |
| 607 | D | D | D | D | D | | | | | | D | | | |
| 608 | D | D | D | D | D | | | | | | | | | D |
| 609 | D | D | D | D | D | | | | | | | D | D | D |
| 610 | D | D | D | D | D | | D | | | | D | | | |
| 611 | D | D | D | D | D | | D | | | | | | | D |
| 612 | D | D | D | D | D | | D | | | | | D | D | D |
| 613 | D | D | D | D | D | | D | D | | | D | | | |
| 614 | D | D | D | D | D | | D | D | | | | | | D |
| 615 | D | D | D | D | D | | D | D | | | | D | D | D |
| 616 | D | D | D | D | D | | D | | D | | D | | | |
| 617 | D | D | D | D | D | | D | | D | | | | | D |
| 618 | D | D | D | D | D | | D | | D | | | D | D | D |
| 619 | D | D | D | D | D | | D | D | D | D | D | | | |
| 620 | D | D | D | D | D | | D | D | D | D | | | | D |
| 621 | D | D | D | D | D | | D | D | D | D | | D | D | D |
| 622 | D | D | D | D | D | D | D | | | | | | | |
| 623 | D | D | D | D | D | D | D | D | | | | | | |
| 624 | D | D | D | D | D | D | D | | D | | | | | |
| 625 | D | D | D | D | D | D | D | D | D | D | | | | |
| 626 | D | D | D | D | D | D | | | | | D | | | |
| 627 | D | D | D | D | D | D | | | | | | | | D |
| 628 | D | D | D | D | D | D | | | | | | D | D | D |
| 629 | D | D | D | D | D | D | D | | | | D | | | |
| 630 | D | D | D | D | D | D | D | | | | | | | D |
| 631 | D | D | D | D | D | D | D | | | | | D | D | D |
| 632 | D | D | D | D | D | D | D | D | | | D | | | |
| 633 | D | D | D | D | D | D | D | D | | | | | | D |
| 634 | D | D | D | D | D | D | D | D | | | | D | D | D |
| 635 | D | D | D | D | D | D | D | | D | | D | | | |
| 636 | D | D | D | D | D | D | D | | D | | | | | D |
| 637 | D | D | D | D | D | D | D | | D | | | D | D | D |
| 638 | D | D | D | D | D | D | D | D | D | D | D | | | |
| 639 | D | D | D | D | D | D | D | D | D | D | | D | | |
| 640 | D | D | D | D | D | D | D | D | D | D | | D | D | D |

TABLE 13
Preferred Compounds of Formula XIV.

| Cmpd | Y^{9a} | Y^{9b} | Y^{9c} | Y^{10a} | Y^{10b} | Y^{11a} | Y^{11b} | Y¹² | Y¹³ | Y¹⁴ | Y¹⁵ |
|---|---|---|---|---|---|---|---|---|---|---|---|
| 641 | D | | | | | | | | | | |
| 642 | D | D | | | | | | | | | |
| 643 | D | D | D | | | | | | | | |
| 644 | | | | D | | | | | | | |
| 645 | | | | D | D | | | | | | |
| 646 | | | | D | | D | | | | | |
| 647 | | | | D | D | D | D | | | | |
| 648 | | | | | | | | D | | | |
| 649 | | | | | | | | | | | D |
| 650 | | | | | | | | | D | D | D |
| 651 | | | | D | | | | D | | | |
| 652 | | | | D | | | | | | | D |
| 653 | | | | D | | | | | D | D | D |
| 654 | | | | D | D | | | D | | | |
| 655 | | | | D | D | | | | | | D |
| 656 | | | | D | D | | | | D | D | D |
| 657 | | | | D | | D | | D | | | |
| 658 | | | | D | | D | | | | | |
| 659 | | | | D | | D | | | D | D | D |
| 660 | | | | D | D | D | D | D | | | |
| 661 | | | | D | D | D | D | | | | D |
| 662 | | | | D | D | D | D | | D | D | D |
| 663 | D | | | D | | | | | | | |
| 664 | D | | | D | D | | | | | | |
| 665 | D | | | D | | D | | | | | |
| 666 | D | | | D | D | D | D | | | | |
| 667 | D | | | | | | | D | | | |
| 668 | D | | | | | | | | | | D |
| 669 | D | | | | | | | | D | D | D |
| 670 | D | | | D | | | | D | | | |
| 671 | D | | | D | | | | | | | D |
| 672 | D | | | D | | | | | D | D | D |
| 673 | D | | | D | D | | | D | | | |
| 674 | D | | | D | D | | | | | | D |
| 675 | D | | | D | D | | | | D | D | D |
| 676 | D | | | D | | D | | D | | | |
| 677 | D | | | D | | D | | | | | D |
| 678 | D | | | D | | D | | | D | D | D |
| 679 | D | | | D | D | D | D | D | | | |
| 680 | D | | | D | D | D | D | | | | D |
| 681 | D | | | D | D | D | D | | D | D | D |
| 682 | D | D | | D | | | | | | | |
| 683 | D | D | | D | D | | | | | | |
| 684 | D | D | | D | | D | | | | | |
| 685 | D | D | | D | D | D | D | | | | |
| 686 | D | D | | | | | | D | | | |
| 687 | D | D | | | | | | | | | D |
| 688 | D | D | | | | | | | D | D | D |
| 689 | D | D | | D | | | | D | | | |
| 690 | D | D | | D | | | | | | | D |
| 691 | D | D | | D | | | | | D | D | D |
| 692 | D | D | | D | D | | | D | | | |
| 693 | D | D | | D | D | | | | | | D |
| 694 | D | D | | D | D | | | | D | D | D |
| 695 | D | D | | D | | D | | D | | | |
| 696 | D | D | | D | | D | | | | | D |
| 697 | D | D | | D | | D | | | D | D | D |
| 698 | D | D | | D | D | D | D | D | | | |
| 699 | D | D | | D | D | D | D | | | | D |
| 700 | D | D | | D | D | D | D | | D | D | D |
| 701 | D | D | D | D | | | | | | | |
| 702 | D | D | D | D | D | | | | | | |
| 703 | D | D | D | D | | D | | | | | |
| 704 | D | D | D | D | D | D | D | | | | |
| 705 | D | D | D | | | | | D | | | |
| 706 | D | D | D | | | | | | | | D |
| 707 | D | D | D | | | | | | D | D | D |
| 708 | D | D | D | D | | | | D | | | |
| 709 | D | D | D | D | | | | | | | D |
| 710 | D | D | D | D | | | | | D | D | D |
| 711 | D | D | D | D | D | | | D | | | |
| 712 | D | D | D | D | D | | | | | | D |
| 713 | D | D | D | D | D | | | | D | D | D |
| 714 | D | D | D | D | | D | | D | | | |
| 715 | D | D | D | D | | D | | | | | D |
| 716 | D | D | D | D | | D | | | D | D | D |
| 717 | D | D | D | D | D | D | D | D | | | |
| 718 | D | D | D | D | D | D | D | | | | D |
| 719 | D | D | D | D | D | D | D | | D | D | D |
| 720 | D | D | D | D | D | D | D | D | D | D | D |

More preferred is a compound selected from any one of the compounds set forth in Table 1, 2 or 6-13. Even more preferred is a compound selected from any one of Compounds 1-8, 11, 90, 96, 169, 175, 248, 254, 327, 333, 406, 412, 485, 491, 564, 570, 643, or 649. Most preferred is a compound selected from any one of Compounds 1 to 8, 90, 169, 248, 485, 564, or 643.

The compounds of the invention may be synthesized by well-known techniques. The starting materials and certain intermediates used in the synthesis of the compounds of this invention are available from commercial sources or may themselves be synthesized using reagents and techniques known in the art, including those synthesis schemes delineated herein. See, for instance, Berglund R A. U.S. Pat. No. 5,362,886 to Eli Lilly; Berglund R A, U.S. Pat. No. 5,491,243 to Eli Lilly; Kjell D P and Lorenz K P, U.S. Pat. No. 6,541,668; Liu H et. al., Chirality 2000 12: 26; Mitchell D and Koenig T M, Synth. Commun. 1995 25: 1231; Wheeler W J and Kuo F, J. Labelled Compd Radiopharm 1995, 36: 213; Kuo F et. al. Bioorg. Med. Chem. Lett. 2004 14: 3481; Ohkuma T et. al. Org. Lett. 2000 2: 1749); Rao D R et. al. World patent WO2004056795 published 07 Aug 04, Cipla Ltd. Applicant. Each of these documents is incorporated herein by reference. Additional synthetic approaches and protocols can readily be discerned by the skilled artesian, for instance with the assistance of commercial structure-searchable chemical compound and reaction databases such as SciFinder (CAS Division of the American Chemical Society) and CrossFire Beilstein (Elsevier MDL®).

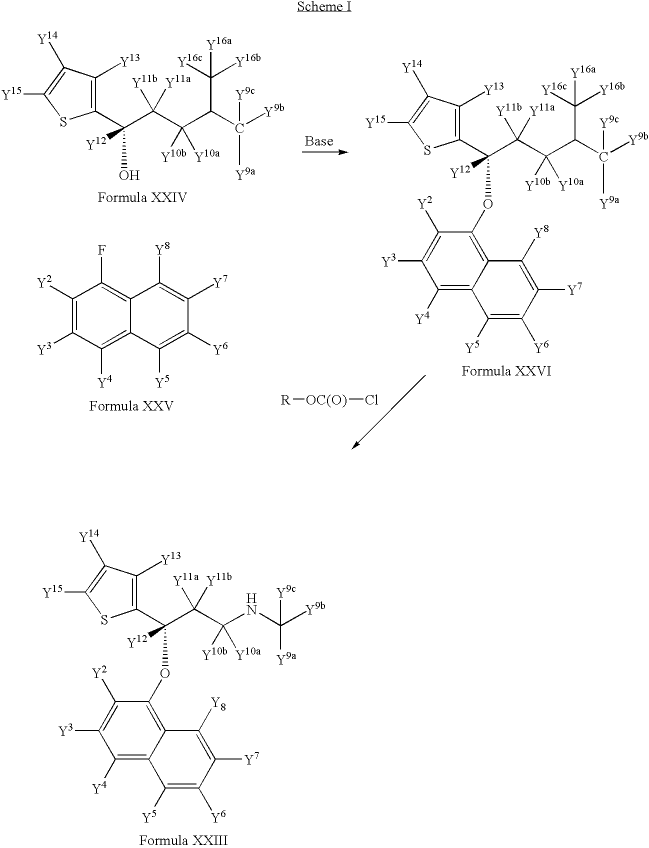

In Scheme I, each Y is independently selected from hydrogen or deuterium and each carbon atom is optionally replaced with ¹³C. Bases include strong deprotonating agents known in the art of organic synthesis and preferably those comprising alkali metal bases such as sodium, potassium and lithium. Potassium hydride and especially sodium hydride are more preferred bases.

In addition to the examples set forth below, many additional ¹³C-containing starting materials are available and can be incorporated into compounds of this invention by means known to those of skill in the art of organic synthesis. For instance, vendors such as Aldrich Chemicals and their subsidiary Isotec (Miamisburg, Ohio), Cambridge Isotope Laboratories (Andover, Mass.), Icon Isotopes (Summit, N.J.); C/D/N Isotopes (Pointe-Claire, Quebec) and Medical Isotopes Inc. (Pelham, N.H.), among others, routinely stock a wide array of ¹³C-labeled reagents, in many cases co-labeled with other stable isotopes such as deuterium. Intermediates and final compounds of this invention including ¹³C can be made with no or only slight modification to routes useful for the ¹²C isotopologues. Any optimization for a particular ¹³C-labeled compound is within the ability of the ordinarily skilled synthetic chemist. Synthetic routes to ¹³C-labeled compounds useful as starting materials or intermediates to compounds of formula I are also available in commercial databases such as SciFinder (CAS Division of the American Chemical Society) or can be readily designed based on routes known for ¹²C isotopologues. Thus, the skilled artesian has the means to design and synthesize singly and multiply-¹³C-labeled compounds of this invention.

In cases where incorporation of stable heavy atom isotopes in the N-methyl position is desired, it can be advantageous to use a modification of this process, shown herein as Scheme II. According to this method, a suitably protected mono-N-methyl analog of Formula XXVII, wherein Q is a removable protecting group, is prepared and then reacted with an appropriate naphthalene derivative XXV. N-Deprotection then yields the desired compound of Formula XXIII. Particularly useful N-protecting groups are alkyl derivatives, including benzyl derivatives such as benzyl, p-methoxybenzyl, 2,4-dimethoxybenzyl, trityl, 5′-dibenzosuberyl 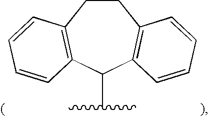
and the like. Other useful protecting groups will be apparent to those of skill in the art.

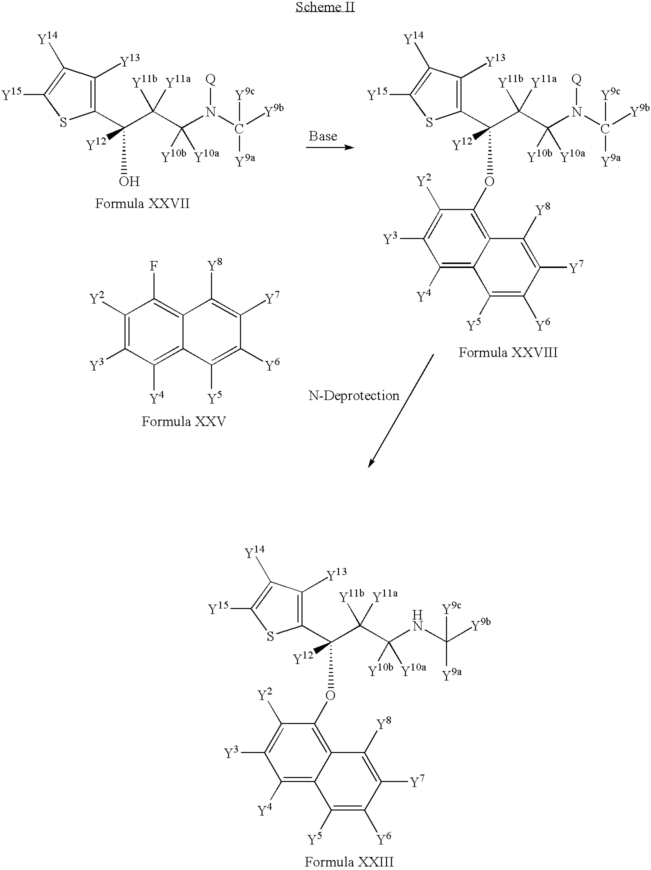

Compounds of Formulae XXIV and XXVII may be advantageously be derived by asymmetric chiral reduction of a precursor ketone, itself derived from addition of thiophene-2-anion to an acyl derivative such as an N,O-dimethylhydroxylamine amide or imidazole amide. See Ohkuma T et. al. Org. Lett. 2000 2: 1749. Other methods will be apparent to those of ordinary skill in synthetic chemistry.

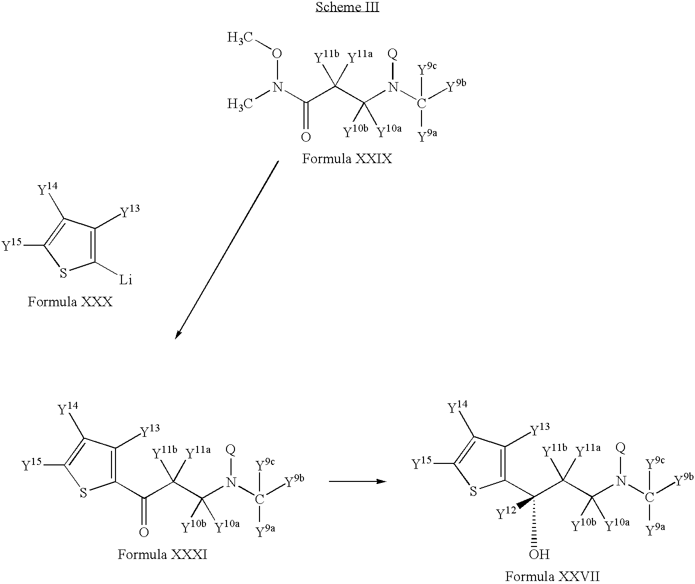

A particularly useful approach to making compounds of Formula XXVII is shown in Scheme III. In this scheme, compounds of Formula XXIX (wherein each Y is independently hydrogen or deuterium) are precursors incorporating, as appropriate, a removable nitrogen protecting group Q such as are known in the art. Scheme III may alternately be used to produce a compound of Formula XXIV if Q on a compound of Formula XXIX is replaced with a C(Y^{16a}) (Y^{16b}) (Y^{16c}) group, wherein each of Y^{16a}, Y^{16b}, Y^{16c}, is independently hydrogen or deuterium.

Another embodiment is a compound of any of the formulae herein made by a process delineated herein, including the processes exemplified in the schemes and examples herein. The chemicals used in the synthetic routes described herein may include, for example, solvents, reagents, catalysts, and protecting group and deprotecting group reagents. The methods described herein may also additionally include steps, either before or after the steps described specifically herein, to add or remove suitable protecting groups in order to ultimately allow synthesis of the compounds herein. In addition, various synthetic steps may be performed in an alternate sequence or order to give the desired compounds. Synthetic chemistry transformations and protecting group methodologies (protection and deprotection) useful in synthesizing the applicable compounds are known in the art and include, for example, those described in R. Larock, Comprehensive Organic Transformations, VCH Publishers (1989); T. W. Greene and P. G. M. Wuts, Protective Groups in Organic Synthesis, 3R^{d} Ed., John Wiley and Sons (1999); L. Fieser and M. Fieser, Fieser and Fieser's Reagents for Organic Synthesis, John Wiley and Sons (1994); and L. Paquette, ed., Encyclopedia of Reagents for Organic Synthesis, John Wiley and Sons (1995) and subsequent editions thereof.

The methods described herein may also additionally include steps, either before or after the steps described specifically herein, to add or remove suitable protecting groups in order to ultimately allow synthesis of the compound of the formulae described herein. The methods delineated herein contemplate converting compounds of one formula to compounds of another formula. The process of converting refers to one or more chemical transformations, which can be performed in situ, or with isolation of intermediate compounds. The transformations can include reacting the starting compounds or intermediates with additional reagents using techniques and protocols known in the art, including those in the references cited herein. Intermediates can be used with or without purification (e.g., filtration, distillation, crystallization, chromatography).

According to another embodiment, the invention provides a compound of above-described formula XXVIII, wherein at least one Y is deuterium.

According to another embodiment, the invention provides a compound of above-described formula XXV, wherein from one to six Y moieties are deuterium and wherein any carbon atom is optionally replaced with a ¹³C atom. Preferably, at least one of Y³, Y⁴, Y⁵ and Y⁶ are deuterium.

According to a preferred embodiment, the invention provides a compound of above-described formula XXV, wherein either Y³ and Y⁴; or Y⁵ and Y⁶; are deuterium.

According to another preferred embodiment, the invention provides a compound of above-described formula XXV, wherein each of Y³, Y⁴, Y⁵ and Y⁶ are deuterium.

According to another preferred embodiment, the invention provides a compound of above-described formula XXV, wherein each of Y², Y³, Y⁴, Y⁵, Y⁶, Y⁷ and Y⁸ are deuterium.

According to another embodiment, the invention provides a compound of above-described formula XXVII, wherein at least one Y is deuterium.

Combinations of substituents and variables envisioned by this invention are only those that result in the formation of stable compounds. The term “stable”, as used herein, refers to compounds which possess stability sufficient to allow manufacture and which maintain the integrity of the compound for a sufficient period of time to be useful for the purposes detailed herein (e.g., formulation into therapeutic products, intermediates for use in production of therapeutic compounds, isolatable or storable intermediate compounds, treating a disease or condition characterized by decreased levels of serotonin or norepinepherine).

The compounds of this invention include the compounds themselves, or a prodrug thereof; or a pharmaceutically acceptable salt of said compound or prodrug; or a solvate, hydrate, and/or polymorph of said compound, salt, prodrug or prodrug salt, if applicable. As used herein, the term “pharmaceutically acceptable salt,” is a salt formed from, for example, an acid and a basic group of a compound of any one of the formulae disclosed herein. Acids commonly employed to form such salts include inorganic acids such as hydrochloric, hydrobromic, hydroiodic, sulfuric and phosphoric acid, as well as organic acids such as para-to 1 uenesulfonic, methanesulfonic, oxalic, para-bromophenylsulfonic carbonic, succinic, citric, benzoic and acetic acid, and related inorganic and organic acids. Such pharmaceutically acceptable salts thus include sulfate, pyrosulfate, bisulfate, sulfite, bisulfite, phosphate, monohydrogenphosphate, dihydrogenphosphate, metaphosphate, pyrophosphate, chloride, bromide, iodide, acetate, propionate, decanoate, caprylate, acrylate, formate, isobutyrate, caprate, heptanoate, propiolate, oxalate, malonate, succinate, suberate, sebacate, fumarate, maleate, butyne-1,4-dioate, hexyne-1,6-dioate, benzoate, chlorobenzoate, methylbenzoate, dinitrobenzoate, hydroxybenzoate, methoxybenzoate, phthalate, terephathalate, sulfonate, xylenesulfonate, phenylacetate, phenylpropionate, phenylbutyrate, citrate, lactate, β-hydroxybutyrate, glycolate, maleate, tartrate, methanesulfonate, propanesulfonate, naphthalene-1-sulfonate, naphthalene-2-sulfonate, mandelate and the like salts. Preferred pharmaceutically acceptable acid addition salts include those formed with mineral acids such as hydrochloric acid and hydrobromlc acid, and especially those formed with organic acids such as maleic acid.

As used herein, the term “hydrate” means a compound of the present invention or a salt thereof, which further includes a stoichiometric or non-stoichiometric amount of water bound by non-covalent intermolecular forces.

The term “solvate” means a compound of the present invention or a salt thereof, which further includes a stoichiometric or non-stoichiometric amount of solvent such as water, acetone, ethanol, methanol, dichloromethane, 2-propanol, or the like, bound by non-covalent intermolecular forces.

As used herein, the term “polymorph” means solid crystalline forms of a compound of the present invention or complex thereof. Different polymorphs of the same compound can exhibit different physical, chemical and/or spectroscopic properties. Different physical properties include, but are not limited to stability (e.g., to heat or light), compressibility and density (important in formulation and product manufacturing), solubility, and dissolution rates (which can affect bioavailability). Differences in stability can result from changes in chemical reactivity (e.g., differential oxidation, such that a dosage form discolors more rapidly when comprised of one polymorph than when comprised of another polymorph) or mechanical characteristics (e.g., tablets crumble on storage as a kinetically favored polymorph converts to thermodynamically more stable polymorph) or both (e.g., tablets of one polymorph are more susceptible to breakdown at high humidity). Different physical properties of polymorphs can affect their processing. For example, one polymorph might be more likely to form solvates or might be more difficult to filter or wash free of impurities than another due to, for example, the shape or size distribution of particles of it.

As used herein and unless otherwise indicated, the term “prodrug” means a derivative of a compound that can hydrolyze, oxidize, or otherwise react under biological conditions (in vitro or in vivo) to provide a compound of this invention. Prodrugs may only become active upon such reaction under biological conditions, or they may have activity in their unreacted forms. Examples of prodrugs contemplated in this invention include, but are not limited to, analogs or derivatives of compounds of any one of the formulae disclosed herein that comprise biohydrolyzable moieties such as biohydrolyzable amides, biohydrolyzable esters, biohydrolyzable carbamates, biohydrolyzable carbonates, biohydrolyzable ureides, and biohydrolyzable phosphate analogues. Other examples of prodrugs include derivatives of compounds of any one of the formulae disclosed herein that comprise —NO, —NO₂, —ONO, or —ONO₂ moieties. Prodrugs can typically be prepared using well-known methods, such as those described by Burger's Medicinal Chemistry and Drug Discovery (1995) 172-178, 949-982 (Manfred E. Wolff ed., 5th ed); see also Goodman and Gilman's, The Pharmacological basis of Therapeutics, 8th ed., McGraw-Hill, Int. Ed. 1992, “Biotransformation of Drugs”.

As used herein and unless otherwise indicated, the terms “biohydrolyzable amide”, “biohydrolyzable ester”, “biohydrolyzable carbamate”, “biohydrolyzable carbonate”, “biohydrolyzable ureide” and “biohydrolyzable phosphate analogue” mean an amide, ester, carbamate, carbonate, ureide, or phosphate analogue, respectively, that either: 1) does not destroy the biological activity of the compound and confers upon that compound advantageous properties in vivo, such as uptake, duration of action, or onset of action; or 2) is itself biologically inactive but is converted in vivo to a biologically active compound. Examples of biohydrolyzable amides include, but are not limited to, lower alkyl amides, α-amino acid amides, alkoxyacyl amides, and alkylaminoalkylcarbonyl amides. Examples of biohydrolyzable esters include, but are not limited to, lower alkyl esters, alkoxyacyloxy esters, alkyl acylamino alkyl esters, and choline esters. Examples of biohydrolyzable carbamates include, but are not limited to, lower alkylamines, substituted ethylenediamines, aminoacids, hydroxyalkylamines, heterocyclic and heteroaromatic amines, and polyether amines.

The term “isotopologue” refers to a species that differs from a compound of this invention only in the isotopic composition of its molecules or ions. The term “lighter isotopologue,” as used herein, refers to species that differs from a compound of this invention in that it comprises one or more of the light isotopic atoms ¹H or ¹²C at positions occupied by a deuterium or ¹³C. For the purposes of this invention, ¹¹C is not referred to as a light isotope of carbon.

It will be readily apparent that all lighter isotopologues except the compound devoid of deuterium and ¹³C (i.e., the corresponding non-deuterated, non-¹³C compound) are compounds according to this invention. Thus, for example, a compound of formula II, wherein Y², Y³ and Y⁴ are each deuterium has lighter isotopologues wherein Y² and Y³ are deuterium and Y⁴ is hydrogen; Y² and Y⁴ are deuterium and Y³ is hydrogen; Y³ and Y⁴ are deuterium and Y² is hydrogen; Y² is deuterium and Y³ and Y⁴ are hydrogen; Y³ is deuterium and Y² and Y⁴ are hydrogen; Y⁴ is deuterium and Y² and Y³ are hydrogen; and Y², Y³ and Y⁴ are all hydrogen, this latter compound being the corresponding non-deuterated, non-¹³C compound.

Chemical naming terminology can be complex and different chemical names can often reasonably be applied to the same structure. To avoid any confusion, “Compound A” refers to the chemical structure shown herein for that compound.

It will be recognized that many commonly occurring atoms in biological systems exist naturally as mixtures of isotopes. Thus, any macroscopic amount of Compound 1, although designated in its formula as being devoid of deuterium and ¹³C, when synthesized inherently contains small amounts of deuterated and ¹³C-containing isotopologues. The present invention excludes such minor amounts of said isotopologues (“variant isotopologues”) from its scope in that the term “compound” as used in this invention refers to a composition of matter that is predominantly the specific carbon and hydrogen isotopologue designated by its formula. A compound, as defined herein, in embodiments contains less than 10%, preferably less than 6%, and more preferably less than 3% of all other carbon and hydrogen isotopologues, including Compound 1, as variant isotopologues. Compositions of matter that contain greater than 10% of all other specific carbon and hydrogen isotopologues combined are referred to herein as mixtures and must meet the parameters set forth below. These limits of isotopic composition, and all references to isotopic composition herein, refer solely to the carbons and hydrogens of the compound of Formula I and do not include the isotopic composition of other atom types, for instance solvent entrapped as a solvate or excipients used in formulating compounds of this invention.

The term “heavy atom” refers to isotopes of higher atomic weight than the predominant naturally occurring isotope.

The term “stable heavy atom” refers to non-radioactive heavy atoms.

Both “²H” and “D” refer to deuterium.

“Stereoisomer” refers to both enantiomers and diastereomers

“NMR” refers to nuclear magnetic resonance spectroscopy

“cGMP” in the context of a chemical agent refers to cyclic guanosine monophosphate

“5′-GMP” refers to guanosine-5′-monophosphate

“cAMP” refers to cyclic adenosine monophosphate

“5′-AMP” refers to adenosine-5′-monophosphate

“Antagonist” refers to both antagonists and inverse agonists

“PM” refers to poor metabolizer

“EM” refers to extensive metabolizer

“AIBN” refers to 2,2′-azo-bis(isobutyronitrile)

“Alloc” refers to allyloxycarbonyl

“Boc” refers to tert-butoxycarbonyl

“Cbz” refers to benzyloxycarbonyl or carbobenzyloxy

“Fmoc” refers to 9-fluorenylmethoxycarbonyl

“MeOH” refers to methanol

“EtOH” refers to ethanol

“AcOH” and “HOAc” both refer to acetic acid

“THF” refers to tetrahydrofuran

“DMF” refers to N,N-dimethylformamide

“aq.” refers to aqueous

“h” refers to hours

“min” refers to minutes

“brine” refers to saturated aqueous sodium chloride

“US” refers to the United States of America

“FDA” refers to Food and Drug Administration

“IND” refers to Investigational New Drug

“NDA” refers to New Drug Application

“cGMP” in the context of synthesis or manufacturing of drug substance or drug product refers to current Good Manufacturing Practices

“CAS” refers to the chemical abstracts service of the American Chemical Society

“AUC” refers to area under the plasma-time concentration curve

“CYP1A2” refers to cytochrome P450 oxidase isoform 1A2

“CYP3A4” refers to cytochrome P450 oxidase isoform 3A4

“CYP2D6” refers to cytochrome P450 oxidase isoform 2D6

“MC-4R” refers to the human melanocortin-4 receptor

“5-HT” refers to 5-hydroxytryptamine or serotonin

“NEP” refers to neutral endopeptidease (EC 3.4.24.11)

“HMG-CoA” refers to 3-hydroxy-3-methylglutaryl-coenzyme A

“ETA” refers to endothelin subtype A receptors

“ETB” refers to endothelin subtype B receptors

“PPAR” refers to peroxisome proliferator-activated receptor

Both “patient” and “subject” used in the context of methods of treatment according to this invention refer to a mammal, preferably an economically important species such as pets and livestock, and more preferably a human.

The invention further provides a mixture of a compound of this invention and its lighter isotopologues. These mixtures may occur, for instance, simply as the result of an inefficiency of incorporating the isotope at a given position; intentional or inadvertent exchange of protons for deuterium, e.g. exchange of bulk solvent for heteroatom-attached deuterium; or intentional mixtures of pure compounds.

In one embodiment, such mixtures comprise at least about 50% of the full isotopic compound (i.e., less than about 50% of lighter isotopologues). More preferable is a mixture comprising at least 80% of the full isotopic compound. Even more preferable is a mixture comprising at least 90% of the full isotopic compound. Even more preferable is a mixture comprising at least 95% of the full isotopic compound. Most preferred is a mixture comprising at least 98% of the full isotopic compound.

In an alternate embodiment the mixture comprises a compound and its lighter isotopologues in relative proportions such that at least about 50%, preferably at least 80%, more preferably at least 90%, even more preferably at least 95% and most preferably at least 98% of the compounds in said mixture comprise an isotope at each position containing an isotope in the full isotopic compound. The following exemplifies this definition. A hypothetical compound of the invention contains deuterium at positions Y², Y³ and Y⁴. A mixture comprising this compound and all of its potential lighter isotopologues and the relative proportion of each is set forth in the table below.

TABLE 14

| | | | | Relative |
|---|---|---|---|---|
| | Y² | Y³ | Y⁴ | Amt |
| Compound | D | D | D | 40% |
| Isotopologue 1 | D | D | H | 15% |
| Isotopologue 2 | D | H | D | 15% |
| Isotopologue 3 | H | D | D | 15% |
| Isotopologue 4 | D | H | H | 4% |
| Isotopologue 5 | H | D | H | 4% |
| Isotopologue 6 | H | H | D | 4% |
| Isotopologue 7 | H | H | H | 3% |
| % of | (40% + 15% + 15% + 4%) = | 74% | 74% | 74% |
| compounds | | | | |
| comprising an | | | | |
| isotope at | | | | |
| position Y² | | | | |

From the table it can be seen that the compound plus lighter isotopologues 1, 2 and 4 comprises the isotope deuterium at position Y². These compounds are present in the mixture at relevant amounts of 40%, 15%, 15% and 4%. Thus, 74% of the mixture comprises the isotope at Y² that is present in the compound.

The invention also provides compositions comprising an effective amount of a compound of Formula I (e.g., including any of the formulae herein), or a prodrug thereof; or a pharmaceutically acceptable salt of said compound or prodrug; or a solvate, hydrate, and/or polymorph of said compound, salt, prodrug or prodrug salt, if applicable; and an acceptable carrier. Preferably, a composition of this invention is formulated for pharmaceutical use (“a pharmaceutical composition”), wherein the carrier is a pharmaceutically acceptable carrier. The carrier(s) must be “acceptable” in the sense of being compatible with the other ingredients of the formulation and, in the case of a pharmaceutically acceptable carrier, not deleterious to the recipient thereof in amounts typically used in medicaments.

Pharmaceutically acceptable carriers, adjuvants and vehicles that may be used in the pharmaceutical compositions of this invention include, but are not limited to, ion exchangers, alumina, aluminum stearate, lecithin, serum proteins, such as human serum albumin, buffer substances such as phosphates, glycine, sorbic acid, potassium sorbate, partial glyceride mixtures of saturated vegetable fatty acids, water, salts or electrolytes, such as protamine sulfate, disodium hydrogen phosphate, potassium hydrogen phosphate, sodium chloride, zinc salts, colloidal silica, magnesium trisilicate, polyvinyl pyrrolidone, cellulose-based substances, polyethylene glycol, sodium carboxymethylcellulose, polyacrylates, waxes, polyethylene-polyoxypropylene-block polymers, polyethylene glycol and wool fat.

The pharmaceutical compositions of the invention include those suitable for oral, rectal, nasal, topical (including buccal and sublingual), vaginal or parenteral (including subcutaneous, intramuscular, intravenous and intradermal) administration. In certain embodiments, the compound of the formulae herein is administered transdermally (e.g., using a transdermal patch or iontophoretic techniques). Other formulations may conveniently be presented in unit dosage form, e.g., tablets and sustained release capsules, and in liposomes, and may be prepared by any methods well known in the art of pharmacy. See, for example, Remington's Pharmaceutical Sciences, Mack Publishing Company, Philadelphia, Pa. (17th ed. 1985).

Such preparative methods include the step of bringing into association with the molecule to be administered ingredients such as the carrier that constitutes one or more accessory ingredients. In general, the compositions are prepared by uniformly and intimately bringing into association the active ingredients with liquid carriers, liposomes or finely divided solid carriers or both, and then if necessary shaping the product.

In certain preferred embodiments, the compound is administered orally. Compositions of the present invention suitable for oral administration may be presented as discrete units such as capsules, sachets or tablets each containing a predetermined amount of the active ingredient; as a powder or granules; as a solution or a suspension in an aqueous liquid or a non-aqueous liquid; or as an oil-in-water liquid emulsion or a water-in-oil liquid emulsion, or packed in liposomes and as a bolus, etc.

A tablet may be made by compression or molding, optionally with one or more accessory ingredients. Compressed tablets may be prepared by compressing in a suitable machine the active ingredient in a free-flowing form such as a powder or granules, optionally mixed with a binder, lubricant, inert diluent, preservative, surface-active or dispersing agent. Molded tablets may be made by molding in a suitable machine a mixture of the powdered compound moistened with an inert liquid diluent. The tablets optionally may be coated or scored and may be formulated so as to provide slow or controlled release of the active ingredient therein. Methods of formulating such slow or controlled release compositions of pharmaceutically active ingredients, such as those herein and other compounds known in the art, are known in the art and described in several issued US Patents, some of which include, but are not limited to, U.S. Pat. Nos. 4,369,172; and 4,842,866, and references cited therein. Coatings can be used for delivery of compounds to the intestine (see, e.g., U.S. Pat. Nos. 6,638,534, 5,217,720, and 6,569,457, 6,461,631, 6,528,080, 6,800,663, and references cited therein). A useful formulation for the compounds of this invention is the form of enteric pellets of which the enteric layer comprises hydroxypropylmethylcellulose acetate succinate. Formulation of this type has been shown to be useful for Compound A. See Anderson N R et. al., U.S. Pat. No. 5,508,276, incorporated herein by reference.

In the case of tablets for oral use, carriers that are commonly used include lactose and corn starch. Lubricating agents, such as magnesium stearate, are also typically added. For oral administration in a capsule form, useful diluents include lactose and dried cornstarch. When aqueous suspensions are administered orally, the active ingredient is combined with emulsifying and suspending agents. If desired, certain sweetening and/or flavoring and/or coloring agents may be added.

Compositions suitable for topical administration include lozenges comprising the ingredients in a flavored basis, usually sucrose and acacia or tragacanth; and pastilles comprising the active ingredient in an inert basis such as gelatin and glycerin, or sucrose and acacia.

Compositions suitable for parenteral administration include aqueous and non-aqueous sterile injection solutions which may contain anti-oxidants, buffers, bacteriostats and solutes which render the formulation isotonic with the blood of the intended recipient; and aqueous and non-aqueous sterile suspensions which may include suspending agents and thickening agents. The formulations may be presented in unit-dose or multi-dose containers, for example, sealed ampules and vials, and may be stored in a freeze dried (lyophilized) condition requiring only the addition of the sterile liquid carrier, for example water for injections, immediately prior to use. Extemporaneous injection solutions and suspensions may be prepared from sterile powders, granules and tablets.

Such injection solutions may be in the form, for example, of a sterile injectable aqueous or oleaginous suspension. This suspension may be formulated according to techniques known in the art using suitable dispersing or wetting agents (such as, for example, Tween 80) and suspending agents. The sterile injectable preparation may also be a sterile injectable solution or suspension in a non-toxic parenterally-acceptable diluent or solvent, for example, as a solution in 1,3-butanediol. Among the acceptable vehicles and solvents that may be employed are mannitol, water, Ringer's solution and isotonic sodium chloride solution. In addition, sterile, fixed oils are conventionally employed as a solvent or suspending medium. For this purpose, any bland fixed oil may be employed including synthetic mono- or diglycerides. Fatty acids, such as oleic acid and its glyceride derivatives are useful in the preparation of injectables, as are natural pharmaceutically-acceptable oils, such as olive oil or castor oil, especially in their polyoxyethylated versions. These oil solutions or suspensions may also contain ethanol or a longer-chain alcohol diluent or dispersant.

The pharmaceutical compositions of this invention may be administered in the form of suppositories for rectal administration. These compositions can be prepared by mixing a compound of this invention with a suitable non-irritating excipient which is solid at room temperature but liquid at the rectal temperature and therefore will melt in the rectum to release the active components. Such materials include, but are not limited to, cocoa butter, beeswax and polyethylene glycols.

Topical administration of the pharmaceutical compositions of this invention is especially useful when the desired treatment involves areas or organs readily accessible by topical application. For application topically to the skin, the pharmaceutical composition should be formulated with a suitable ointment containing the active components suspended or dissolved in a carrier. Carriers for topical administration of the compounds of this invention include, but are not limited to, mineral oil, liquid petroleum, white petroleum, propylene glycol, polyoxyethylene polyoxypropylene compound, emulsifying wax and water. Alternatively, the pharmaceutical composition can be formulated with a suitable lotion or cream containing the active compound suspended or dissolved in a carrier. Suitable carriers include, but are not limited to, mineral oil, sorbitan monostearate, polysorbate 60, cetyl esters wax, cetearyl alcohol, 2-octyldodecanol, benzyl alcohol and water. The pharmaceutical compositions of this invention may also be topically applied to the lower intestinal tract by rectal suppository formulation or in a suitable enema formulation. Topically-transdermal patches and iontophoretic administration are also included in this invention.

The pharmaceutical compositions of this invention may be administered by nasal aerosol or inhalation. Such compositions are prepared according to techniques well-known in the art of pharmaceutical formulation and may be prepared as solutions in saline, employing benzyl alcohol or other suitable preservatives, absorption promoters to enhance bioavailability, fluorocarbons, and/or other solubilizing or dispersing agents known in the art.

Particularly favored derivatives and prodrugs are those that increase the bioavailability of the compounds of this invention when such compounds are administered to a mammal (e.g., by allowing an orally administered compound to be more readily absorbed into the blood) or which enhance delivery of the parent compound to a biological compartment (e.g., the brain or central nervous system) relative to the parent species. Preferred prodrugs include derivatives where a group that enhances aqueous solubility or active transport through the gut membrane is appended to the structure of formulae described herein. See, e.g., Alexander, J. et al. Journal of Medicinal Chemistry 1988, 31, 318-322; Bundgaard, H. Design of Prodrugs; Elsevier: Amsterdam, 1985; pp 1-92; Bundgaard, H.; Nielsen, N. M. Journal of Medicinal Chemistry 1987, 30, 451-454; Bundgaard, H. A Textbook of Drug Design and Development; Harwood Academic Publ.: Switzerland, 1991; pp 113-191; Digenis, G. A. et. al. Handbook of Experimental Pharmacology 1975, 28, 86-112; Friis, G. J.; Bundgaard, H. A Textbook of Drug Design and Development; 2 ed.; Overseas Publ.: Amsterdam, 1996; pp 351-385; Pitman, I. H. Medicinal Research Reviews 1981, 1, 189-214.

Application of the subject therapeutics may be local, so as to be administered at the site of interest. Various techniques can be used for providing the subject compositions at the site of interest, such as injection, use of catheters, trocars, projectiles, pluronic gel, stents, sustained drug release polymers or other device which provides for internal access.

Thus, according to yet another embodiment, the compounds of this invention may be incorporated into compositions for coating an implantable medical device, such as prostheses, artificial valves, vascular grafts, stents, or catheters. Suitable coatings and the general preparation of coated implantable devices are described in U.S. Pat. Nos. 6,099,562; 5,886,026; and 5,304,121. The coatings are typically biocompatible polymeric materials such as a hydrogel polymer, polymethyldisiloxane, polycaprolactone, polyethylene glycol, polylactic acid, ethylene vinyl acetate, and mixtures thereof. The coatings may optionally be further covered by a suitable topcoat of fluorosilicone, polysaccharides, polyethylene glycol, phospholipids or combinations thereof to impart controlled release characteristics in the composition. Coatings for invasive devices are to be included within the definition of pharmaceutically acceptable carrier, adjuvant or vehicle, as those terms are used herein.

According to another embodiment, the invention provides a method of coating an implantable medical device comprising the step of contacting said device with the coating composition described above. It will be obvious to those skilled in the art that the coating of the device will occur prior to implantation into a mammal.

According to another embodiment, the invention provides a method of impregnating an implantable drug release device comprising the step of contacting said drug release device with a compound or composition of this invention. Implantable drug release devices include, but are not limited to, biodegradable polymer capsules or bullets, non-degradable, diffusible polymer capsules and biodegradable polymer wafers.

According to another embodiment, the invention provides an implantable medical device coated with a compound or a composition comprising a compound of this invention, such that said compound is therapeutically active.

According to another embodiment, the invention provides an implantable drug release device impregnated with or containing a compound or a composition comprising a compound of this invention, such that said compound is released form said device and is therapeutically active.

Where an organ or tissue is accessible because of removal from the patient, such organ or tissue may be bathed in a medium containing a composition of this invention, a composition of this invention may be painted onto the organ, or a composition of this invention may be applied in any other convenient way.

The present invention further provides pharmaceutical compositions comprising an effective amount of one or more compound of the invention, an Formula I, or a prodrug thereof; or a pharmaceutically acceptable salt of said compound or prodrug; or a solvate, hydrate, and/or polymorph of said compound, salt, prodrug or prodrug salt, in combination with an effective amount of another therapeutic agent useful for treating or preventing depression, obsessive-compulsive disease, aggressive disorder, premature ejaculation, cardiovascular disease, urinary tract disorders, psychosis, acute mania, anxiety, pain, sleep disorders, for reducing associated gastrointestinal side-effects of serotonin reuptake inhibitors, or for potentiating drug activity.

Such other therapeutic agents useful in combination with the compounds of this invention include, but are not limited to, a serotonin 1A receptor antagonist, a beta blocker, L-tryptophan or 5-hydroxy-L-tryptophan; a 5HT4 receptor antagonists, an antihypertensive, an atypical antipsychotic agent, an analgesic, a NSAID, a phosphodiesterase inhibitor, normetanephrine or a normetanephrine precursor, a sertindole derivative, an 8-aza-bicyclo[3.2.1]octan-3-ol derivatives of 2,3-dihydro-1,4-benzodioxan, an azaheterocyclylmethyl derivatives of 7,8-dihydro-1,6,9-trioxa-3-aza-cyclopenta[a]naphthalene, an azabicyclylmethyl derivatives of 2,3-dihydro-1,4-dioxino[2,3-f]quinoline, a 5-HT3 receptor antagonist, or a NK1 antagonist.

Examples of serotonin 1A receptor antagonists include WAY 100135, WAY 100635, spiperone, (S)-UH-301, and compounds disclosed in U.S. Pat. No. 5,532,264, the disclosure of which is herein incorporated by reference.

Examples of beta blockers include alprenolol, penbutolol, pindolol, propranolol and tertatolol.

Examples of 5HT4 receptor antagonists include A-85380, SB 204070, SB 207226, SB 207058, SB 207710, SB 205800, SB 203186, SDZ 205557, N 3389, FK 1052, SC 56184, SC 53606, DAU 6285, GR 125487, GR 113808, RS 23597, RS 39604, LY-353433 or R 50595.

Examples of antihypertensives include moxonidine and pharmaceutically acceptable salts thereof.

Examples of atypical antipsychotic agents include olanzapine; clozapine, risperidone, sertindole, quetiapine, and ziprasidone.

Examples of NSAIDs include salicylic acid, aspirin, methyl salicylate, diflunisal, salsalate, olsalazine, sulfasalazine, indomethacin, sulindac, etodolac, tolmetin, ketorolac, diclofenac, ibuprofen, naproxen, fenoprofen, ketoprofen, flurbiprofen, oxaprozin, piroxicam, celecoxib, and rofecoxib.

Examples of phosphodiesterase inhibitors include anagrelide, bemoradan, ibudilast, isomazole, lixazinone, motapizone, olprinone, phthalazinol, pimobendan, quazinone, siguazodan, trequinsin, amrinone, milrinone, olprinone, etazolate, S-(+)-glaucine, rolipram, sildenafil, zaprinast, dipyridamole, (S)-2-(2-hydroxymethyl-1-pyrrolidinyl)-4-(3-chloro-4-methoxy-benzylamino)-5-[N-(2-pyrimidinylmethyl)carbamoyl]pyrimidine, 2-(5,6,7,8-tetrahydro-1,7-naphthyridin-7-yl)-4-(3-chloro-4-methoxybenzylamino)-5-[N-(2-morpholinoethyl)carbamoyl]-pyrimidine, (S)-2-(2-hydroxymethyl-1-pyrrolidinyl)-4-(3-chloro-4-methoxy-benzylamino)-5-[N-(1,3,5-trimethyl-4-pyrazolyl)carbamoyl]pyrimidine and pharmaceutically acceptable salts, esters, amides, prodrugs, and active metabolites thereof.

Examples of normetanephrine precursors include as 4-hydroxy-3-methoxyphenylserine (4H-3MePs). methoxyphenylserine (4H-3MePS), and L-threo-3-(4-H-3MePS), the latter being especially preferred.

Examples of sertindole derivatives include nor-sertindole, 5-oxo-sertindole, dehydro-sertindole, dehydro-nor-sertindole, and pharmaceutically acceptable salts, solvates, hydrates, and clathrates thereof.

Examples of 8-aza-bicyclo[3.2.1]octan-3-ol derivatives of 2,3-dihydro-1,4-benzodioxan include those that are disclosed in U.S. Pat. No. 6,656,951, the disclosure of which is herein incorporated by reference.

Examples of azaheterocyclylmethyl derivatives of 7,8-dihydro-1,6,9-trioxa-3-aza-cyclopenta[a]naphthalene include those that are disclosed in U.S. Pat. No. 6,815,448, the disclosure of which is herein incorporated by reference.

Examples of azabicyclylmethyl derivatives of 2,3-dihydro-1,4-dioxino[2,3-f]quinoline include those that are disclosed in U.S. Pat. No. 6,861,427, the disclosure of which is herein incorporated by reference.

Examples of 5-HT3 receptor antagonists include indisetron, YM-114 ((R)-2,3-dihydro-1-[(4,5,6,7-tetrahydro-1H-benzimidazol-5-yl)carbonyl]-1H-indole), granisetron, talipexole, azasetron, bemesetron, tropisetron, ramosetron, ondansetron, palonosetron, lerisetron, alosetron, N-3389, zacopride, cilansetron, E-3620 ([3(S)-endo]-4-amino-5-chloro-N-(8-methyl-8-azabicyclo[3.2.1-]oct-3-yl-2[(1-methyl-2-butynyl)oxy]benzamide), lintopride, KAE-393, itasetron, zatosetron, dolasetron, (±)-zacopride, (±)-renzapride, (−)-YM-060, DAU-6236, BIMU-8 and GK-128 ([2-[2-methylimidazol-1-yl)methyl]-benzo[f]thiochromen-1-one monohydrochloride hemihydrate]).

Examples of NK1 antagonists include those that are disclosed in U.S. Pat. No. 6,878,732, the disclosure of which is herein incorporated by reference.

In another embodiment, the invention provides separate dosage forms of a compound of this invention and a second therapeutic agent that are associated with one another. The term “associated with one another” as used herein means that the separate dosage forms are packaged together or otherwise attached to one another such that it is readily apparent that the separate dosage forms are intended to be sold and administered together (within less than 24 hours of one another, consecutively or simultaneously).

In the pharmaceutical compositions of the invention, the compound of the present invention is present in an effective amount. As used herein, the term “effective amount” refers to an amount which, when administered in a proper dosing regimen, is sufficient to reduce or ameliorate the severity, duration or progression of a disorder characterized by reduced interstitial concentrations of serotonin or epinephrine, prevent the advancement of a disorder characterized by reduced interstitial concentrations of serotonin or epinephrine, cause the regression of a disorder characterized by reduced interstitial concentrations of serotonin or epinephrine, or enhance or improve the prophylactic or therapeutic effect(s) of another therapy. In certain preferred embodiments, treatment according to the invention provides a reduction in or prevention of at least one symptom or manifestation of a disorder that has been linked to reduced neurotransmission of serotonin or epinephrine, as determined in vivo or in vitro of at least about 10%, more preferably 20%, 30%, 40%, 50%, 60%, 70%, 80%, 90%, 95%, 98% or 99%. With respect to inhibition of serotonin or norepinephrine reuptake, the term “effective amount” means an amount that results in a detectable increase in the amount or concentration of serotonin or norepinephrine in a patient or in a biological sample, the correction of or relief from a behavior, deficit, symptom, syndrome or disease that has been linked to reduced neurotransmission of serotonin or epinephrine, alone or in combination with another agent or agents; or the induction of a behavior, activity or response that has been linked to normalized or increased neurotransmission of serotonin or epinephrine.

The interrelationship of dosages for animals and humans (based on milligrams per meter squared of body surface) is described in Freireich et al., (1966) Cancer Chemother Rep 50: 219. Body surface area may be approximately determined from height and weight of the patient. See, e.g., Scientific Tables, Geigy Pharmaceuticals, Ardley, N.Y., 1970, 537. An effective amount of a compound of this invention can range from about 0.001 mg/kg to about 500 mg/kg, more preferably 0.01 mg/kg to about 50 mg/kg, more preferably 0.1 mg/kg to about 2.5 mg/kg. Effective doses will also vary, as recognized by those skilled in the art, depending on the diseases treated, the severity of the disease, the route of administration, the sex, age and general health condition of the patient, excipient usage, the possibility of co-usage with other therapeutic treatments such as use of other agents and the judgment of the treating physician.

For pharmaceutical compositions that comprise additional therapeutic agents, an effective amount of the other agent is between about 20% and 100% of the dosage normally utilized in a monotherapy regime using just that additional agent. Preferably, an effective amount is between about 70% and 100% of the normal monotherapeutic dose. The normal monotherapuetic dosages of these additional therapeutic agents are well known in the art. See, e.g., Wells et al., eds., Pharmacotherapy Handbook, 2nd Edition, Appleton and Lange, Stamford, Conn. (2000); PDR Pharmacopoeia, Tarascon Pocket Pharmacopoeia 2000, Deluxe Edition, Tarascon Publishing, Loma Linda, Calif. (2000), each of which references are entirely incorporated herein by reference.

It is expected that some of the additional therapeutic agents listed above will act synergistically with the compounds of this invention. When this occurs, its will allow the effective dosage of the additional therapeutic agent and/or the compound of this invention to be reduced from that required in a monotherapy. This has the advantage of minimizing toxic side effects of either the additional therapeutic agent of a compound of this invention, synergistic improvements in efficacy, improved ease of administration or use and/or reduced overall expense of compound preparation or formulation.

Methods of Treatment

In one embodiment, the present invention provides a method of inhibiting the reuptake of serotonin and norepinephrine in a subject comprising the step of administering to said subject an effective amount of a compound of this invention. Another embodiment of the invention is a method of treating a subject suffering from or susceptible to depression; pain, particularly diabetic neuropathy pain; attention-deficit/hyperactivity disorder; fibromyalgia; psoriasis; interstitial cystitis; or incontinence, said method comprising the step of administering to said subject an effective amount of a compound of this invention. Other embodiments include any of the methods herein wherein the subject is identified as in need of the indicated treatment.

In another embodiment, the method of treatment further comprises the step of administering to said patient another therapeutic agent conventionally used to treat or prevent depression, obsessive-compulsive disease, aggressive disorder, premature ejaculation, cardiovascular disease, urinary tract disorders, psychosis, acute mania, anxiety, pain, sleep disorders, for reducing associated gastrointestinal side-effects of serotonin reuptake inhibitors, or for potentiating drug activity.

The additional therapeutic agent may be administered together with a compound of this invention as part of a single dosage form or as multiple dosage forms. Alternatively, the additional agent may be administered prior to, consecutively with, or following the administration of a compound of this invention. In such combination therapy treatment, both the compounds of this invention and the other therapeutic agent(s) are administered by conventional methods. The administering of the other therapeutic agent may occur before, concurrently with, and/or after the administering of the compound of this invention. When the administering of the other therapeutic agent occurs concurrently with a compound of this invention, the two (or more) agents may be administered in a single dosage form (such as a composition of this invention comprising a compound of the invention and an additional therapeutic agent as described above), or in separate dosage forms. The administration of a composition of this invention comprising both a compound of the invention and an additional therapeutic agent to a subject does not preclude the separate administration of said therapeutic agent, any other therapeutic agent or any compound of this invention to said subject at another time during a course of treatment.

Effective amounts of the other therapeutic agents are well known to those skilled in the art and guidance for dosing may be found in patents referenced herein, as well as in Wells et al., eds., Pharmacotherapy Handbook, 2nd Edition, Appleton and Lange, Stamford, Conn. (2000); PDR Pharmacopoeia, Tarascon Pocket Pharmacopoeia 2000, Deluxe Edition, Tarascon Publishing, Loma Linda, Calif. (2000), and other medical texts. However, it is well within the skilled artisan's purview to determine the other therapeutic agent's optimal effective-amount range. In one embodiment of the invention where another therapeutic agent is administered to an animal, the effective amount of the compound of this invention is less than its effective amount would be where the other therapeutic agent is not administered. In another embodiment, the effective amount of the conventional agent is less than its effective amount would be where the compound of this invention is not administered. In this way, undesired side effects associated with high doses of either agent may be minimized. Other potential advantages (including without limitation improved dosing regimens and/or reduced drug cost) will be apparent to those of skill in the art.

Additional therapeutic agents useful in the method of treatment are the same as those described above as part of combination compositions.

Animal models measuring the uptake of serotonin and norepinephrine have proven useful to predicting the human utility of Compound A and related compounds; see: Robertson D W et. al. U.S. Pat. No. 4,956,388 to Lilly. Similarly, the activity of Compound A in animal models of pain accurately presaged its activity in human pain and sensory disorders: Goldstein D J et. al. U.S. Pat. No. 6,596,756 to Lilly. Each of the compounds of this invention may be tested in such animal models. The compounds of the invention may also be tested in in vitro assays, to quantitate their activity, resistance to liver metabolism compared to the corresponding non-deuterated, non-¹³C compound and therapeutic usefulness.

Diagnostic Methods and Kits

According to another embodiment, the invention provides a method of determining the concentration of a first compound having the formula: 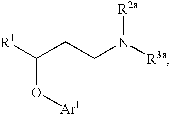
in a biological sample, wherein:
R¹ is selected from C₅-C₇ cycloalkyl, thienyl, halothienyl, (C₁-C₄ alkyl) thienyl, furanyl, pyridyl, or thiazolyl;
Ar is 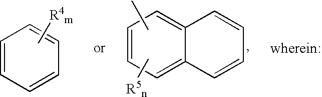
   each R⁴ is independently selected from halo, C₁-C₄ alkyl, C₁-C₃ alkoxy or trifluoromethyl;
   each R⁵ is independently selected from halo, C₁-C₄ alkyl or trifluo-romethyl;
   m is 0, 1 or 2; and
   n is 0 or 1; and
each of R^{2a} and R^{3a} is independently selected from hydrogen or CH₃; said method comprising the steps of:
a) adding a known concentration of a second compound to said biological sample, said second compound having the formula: 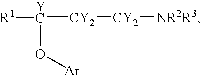
   or an acid addition salt thereof, to said biological sample, wherein:
each Y is independently selected from H or deuterium;
Ar is 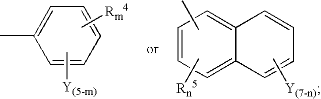
R¹ is the same as R¹ in said first compound;
each of R² and R³ is independently selected from:
   i) hydrogen or deuterium if the corresponding R^{2a} or R^{3a} is hydrogen in said first compound, or
   ii) CY₃ if the corresponding R^{2a} or R^{3a} is in said first compound is methyl;
each carbon atom in said second compound optionally replaced with ¹³C, wherein at least one Y is deuterium or at least one carbon is replaced with ¹³C;
b) subjecting said biological sample to a measuring device that distinguishes said first compound from said second compound;
c) calibrating said measuring device to correlate the detected quantity of said second compound with the known concentration of said second compound added to said biological sample; and
d) determining the concentration of said first compound in said biological sample by comparing the detected quantity of said first compound with the detected quantity and known concentration of said second compound.

Measuring devices that can distinguish said first compound from said second compound include any measuring device that can distinguish between first compound and a second compound that is of identical structure except that it contains one or more deuterium in place of one or more hydrogen, or one or more ¹³C in place of one or more ¹²C. Preferably, such a measuring device is a mass spectrometer.

In a preferred embodiment, the sum of Y moieties that are deuterium and carbon atoms that are replaced by ¹³C in said second compound is three or greater.

In another preferred embodiment, the method comprises the additional step of organically extracting said first and said second compounds from said biological sample prior to step b).

The first and the second compounds will have similar solubility, extraction, and chromatographic properties, but significantly different molecular mass. Thus, the second compound is useful as an internal standard in a method that comprises the step of organic extraction to measure the efficiency of that extraction and to ensure an accurate determination of the true concentration or the first compound (see Tuchman M and McCann M T, Clin. Chem. 1999 45: 571; Leis H J et. al., J. Mass Spectrom. 2001 36: 923; Taylor R L et. al. Clin. Chem. 2002 48: 1511, the disclosures of which are herein incorporated by reference).

The compounds of the present invention (the second compound) are particularly useful in this method since they are not radioactive and therefore do not pose a hazard to personnel handling the compounds. Thus, these methods do not require precautions beyond those normally applied in clinical sample analysis. Furthermore, stably labeled isotopes have long been used to assisting in research into the enzymatic mechanism of cytochrome P450 enzymes (Korzekwa K R et. al., Drug Metab. Rev. 1995 27: 45; Kraus, J A and Guengerich, F P, J. Biol. Chem. 2005 280: 19496; Mitchell K H et. al., Proc. Natl. Acad. Sci. USA 2003 109: 3784).

In a related embodiment, the invention provides a diagnostic kit comprising a diagnostic compound having the formula: 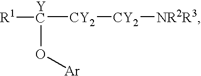
or a pharmaceutically acceptable acid addition salt thereof, as described above, in a sealed vessel, wherein R¹, R², R³, Y and Ar are as defined for a compound of formula I, above; and instructions for using said compound to determine the concentration of a test compound in a biological sample. In a preferred embodiment, the sum of Y moieties that are deuterium and carbon atoms that are replaced by ¹³C in said diagnostic compound is three or greater.

In another embodiment, the invention provides a method of evaluating the metabolic stability of a compound of formula I, comprising the steps of contacting the compound of formula I or its acid addition salt with a metabolizing enzyme source for a period of time; and comparing the amount of said compound and metabolic products of said compounds after said period of time.

In one preferred embodiment, the method comprises an additional step of comparing the amount of said compound and said metabolic products of said compounds at an interval during said period of time. This method allows the determination of a rate of metabolism of said compound.

In another preferred embodiment, the method comprises the additional steps of contacting an isotopologue of said compound with said metabolizing enzyme source; comparing the amount of said isotopologue and metabolic products of said isotopologue after said period of time determining a rate of metabolism of said isotopologue; and comparing the metabolic stability of said compound and said isotopologue. This method is useful in determining at which sites on the compound a deuterium or ¹³C would cause the greatest increase in metabolic stability. It is also useful in determining if a compound is more metabolically stable than its corresponding non-deuterated, non-¹³C compound.

A metabolizing enzyme source may be a purified, isolated or partially purified metabolic protein, such as a cytochrome P450; a biological fraction, such as a liver microsome fraction; or a piece of a metabolizing organ, such as a liver slice.

The determination of the amount of compound and its metabolic products is well known in the art. It is typically achieved by removing an aliquot from the reaction mixture and subjecting it to an analysis capable of distinguishing between the compound and its metabolites, such as reversed-phase HPLC with UV absorption or mass spectroscopic detection. Concentrations of both the metabolizing enzyme and the compound may be varied to determine kinetic parameters, for instance, by using appropriate nonlinear regression software such as is known in the art. By comparing the kinetic parameters of both a compound and the corresponding non-deuterated, non-¹³C isotopologue an apparent steady-state deuterium isotope effect (^{D}(V/K)) can be determined as the ratio of products formed in the hydrogen versus deuterium reactions.

The determination of a rate of metabolism of an isotopologue may be achieved in a reaction separate from the reaction for determining the metabolism rate of the compound. Alternatively, the compound be admixed with an isotopologue in a competition experiment to determine rates of disappearance of the two compounds, making use of analytical instrumentation capable of differentiating between the two compounds based on their mass differences.

In yet another embodiment, pre-steady state kinetics, such as V₀, may be determined by means known in the art, for instance, using quench-flow apparatus, by monitoring the quenched reactions at varying times after mixing the compound or isotopologue with the metabolizing enzyme source.

In a related embodiment, the invention provides a kit comprising, in separate vessels:
a) a compound of the formula: 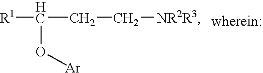
R¹ is C₅-C₇ cycloalkyl, thienyl, halothienyl, (C₁-C₄ alkyl) thienyl, furanyl, pyridyl or thiazolyl;
Ar is 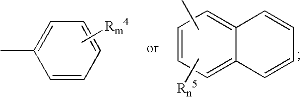
each of R² and R³ independently is hydrogen or methyl;
each R⁴ independently is halo, C₁-C₄ alkyl, C₁-C₃ alkoxy or trifluoromethyl;
each R⁵ independently is halo, C₁-C₄ alkyl or trifluoromethyl;
m is 0, 1 or 2; n is 0 or 1; and
b) a metabolizing enzyme source. The kit is useful for comparing the metabolic stability of a compound of formula I with the corresponding non-deuterated, non-¹³C compound, as well as evaluating the affect of deuterium and ¹³C replacement at various positions on a compound of Formula I. In a preferred embodiment, the kit further comprises instructions for using said compound and said metabolizing enzyme source to evaluate the metabolic stability of a compound of formula I.

In order that the invention might be more fully understood, the following examples are set forth. They are not intended to limit the scope of the invention and further examples will be evident to those of ordinary skill in the art.

### EXAMPLE 1

1-Fluoro-2,3,4,5,6,7,8-heptadeuteronaphthalene. Two synthetic methods are described.

Method A: Cool a solution of 1-naphthol-d₇ (available from Isotec, Miamisburg Ohio, or by the method of Guthrie R D and Shi B, J. Am. Chem. Soc. 1990 112: 3136) (4.0 mmol) in 60 mL of toluene, cooled in an ice/water bath, and treat dropwise over about 1 min with 4.2 mmol of phosgene, followed by dropwise addition during about 1 min 4.2 mmol of N,N-dimethylaniline. After about 10 min, add about 0.5 mL of water dropwise carefully during about 1 min. Dilute the mixture with about 10 mL of toluene and wash sequentially with water, 0.1 N HCl, 0.1 N NaOH, and saturated brine, then dry over anhydrous magnesium sulfate and evaporated to yield an oily residue. Kugelrohr distill to yield naphthyl-1-chloroformate-d₇.

Add anhydrous potassium fluoride (5 mol) to a stirred solution of naphthyl-1-chloroformate-d₇ (3.5 mol) and 18-crown-6 (0.17 mol) in 3 mL of dichloromethane (250 mL) at room temperature. After 5 h, filter the suspension, and evaporate the resulting solution under reduced pressure and purify the resulting oil by vacuum distillation to yield naphthyl-1-fluoroformate-d₇.

Stir a mixture of anhydrous SbF₅ (spatula tip amount, ˜0.5-1 mg) and naphthyl-1-fluoroformate-d₇ (2.5 mol), then heat to about 190° C., where evolution of carbon dioxide commences. Continue heating for about 3 h. Cool the reaction mixture to room temperature, then pour onto ice and extract with dichloromethane (3×). Combine the organic extracts and dry (MgSO₄) and evaporated under reduced pressure. Purify the resulting black oil by vacuum distillation to give 1-fluoronaphthalene-d₇.

Method B: Dissolve 1-Fluoronaphthalene (10 mmol, Acros Organics) in 10 mL of benene-d₆ (Aldrich). Add a spatula tip (˜0.5-1 mg) of [Hg(η2-C₆H₅CH₃)₂(GaCl₄)₂] (Borovik A S et. al. Angew. Chem. Int. Ed. 2000 39: 4117) to the mixture and stir for 2 h. Distill off the deuterobenzene is distilled and take the residue up in fresh benene-d₆, treat with a small amount of [Hg(η2-C₆H₅CH₃)₂(GaCl₄)₂], stir for 2 h, then distilled off the deuterobenzene. Once again dissolve the residue in fresh benene-d₆, treat with a small amount of [Hg(η2-C₆H₅CH₃)₂(GaCl₄)₂], stir for 2 h, and evaporate. Kugelrohr distil to yield 1-fluoronaphthalene-d₇.

### EXAMPLE 2

(S)-N,N-dimethyl-3-(2,3,4,5,6,7,8-heptadeuteronaphthalen-1-yloxy)-3-(thiophene-2-yl)propan-1-amine. Treat a solution of 3.1 mmol (S)-(−)-N,N-dimethyl-3-hydroxy-3-(2-thienyl)propanamine (Berglund, R A, U.S. Pat. No. 5,362,886 to Eli Lilly) in 3 ml of dimethylsulfoxide, under argon at ambient temperature, with 0.12 g of sodium hydride as a 60% dispersion in mineral oil and stir the mixture vigorously. After 30 minutes of stirring, add 90 mg of potassium benzoate and continue stirring for 10 minutes more. Add 3.1 mmol of 1-fluoronaphthalene-d₇ and stir the mixture at 50° C. for 8 hours. Pour the reaction mixture into 30 ml of cold water and adjust the pH to 4.8 by addition of acetic acid. Add 5 mL of hexane, then stir for 10 minutes, and are separate the layers. Stir the aqueous phase again with 15 ml of hexane and separate the phases. Adjust the pH of the aqueous phase to about 12.5 by addition of aqueous sodium hydroxide, and add 15 ml of ethyl acetate. Stir the basic mixture at ambient temperature for 10 minutes, and separate the layers. Extract the aqueous phase with another 15 ml portion of ethyl acetate, and combine the organic extracts, wash with 30 ml of water, dry over magnesium sulfate, and evaporate under vacuum. Dissolve the oily residue in the minimal amount of 1:1 ethyl acetate:hexane and apply to a pad of silica gel, using ethyl acetate:hexane:methanol:amonium hydroxide, 47:47:5.8:0.2 as eluant. Evaporate the product fraction under vacuum to obtain the named product.

### EXAMPLE 3

(S)-N-methyl-3-(2,3,4,5,6,7,8-heptadeuteronaphthalen-1-yloxy)-3-(thiophene-2-yl)propan-1-amine hydrochloride (Compound 8). Heat a solution of 6 mmol of the product of Example 2 in 12 of toluene to 55° C. Then add 7.2 mmol of diisopropylethylamine, followed dropwise by 9 mmol of phenyl chloroformate. Stir the mixture at 55° C. for 1.25 hours, then add 15 ml of 1% sodium bicarbonate solution. Stir the mixture for ten minutes at about 45° C., and separate the phases. Wash the organic phase twice with 0.5N hydrochloric acid, then with 1% sodium bicarbonate solution. Evaporate the washed organic phase under vacuum take up the residue in 30 ml of dimethylsulfoxide. Heat the mixture to 45° C. and add 30 mmol of sodium hydroxide and 36 ml of water dropwise. Stir the basic mixture for about 16 hours at 50° C., dilute with 20 ml of water, and acidify to pH 5.0-5.5 by addition of acetic acid. Add 24 ml of hexane, stir the mixture for ten minutes, and separate the phases. Basify the aqueous phase to pH ˜10.5 by addition of 50% aqueous sodium hydroxide, and add 17 ml of ethyl acetate. After stirring for 15 minutes, separate the phases, and extract the aqueous layer with ethyl acetate. Wash the combined organic extracts with brine and concentrate to about 10 ml under vacuum, then treate with 0.55 g of concentrated aqueous hydrochloric acid and an additional 10 mL of ethyl acetate. Stir the mixture for 30 minutes more, and concentrate the solution to about 12 ml under vacuum. Stir the residue for 1 hour at ambient temperature and 1 hour in an ice bath and filtere to yield the named product.

### EXAMPLE 4

Tert-butyl 3-(methoxy(methyl)amino-3-oxopropylcarbamate. Cool a solution of Boc-β-alanine (10.2 mmol; Bachem A G) and diisopropylethylamine (11 mmol) in 40 mL of methylene chloride to −10° C. under nitrogen and treat with 10.5 mmol of ethyl chloroformate during about 10 min. Stir for 20 min, then add additional diisopropylethylamine (12 mmol), followed by N,O-dimethylhydroxylamine hydrochloride (12 mmol). Stir the mixture is overnight, warming slowly to room temperature, then pour into 80 mL each of brine and ether. Separate the organic layer and wash with water and then brine, dry over anhydrous sodium sulfate, and evaporate. Purify the residue by silica gel flash chromatography using an ethyl acetate/hexane eluant to yield the title compound.

### EXAMPLE 5

tert-Butyl-3-oxo-3-(thiophen-2-yl)propylcarbamate. Cool a solution of 6.2 mmol of 2-bromothiophene in 20 mL of dry ether in an acetone-dry ice bath and treat during about 10 min with 6.0 mmol of 1 N N-butyllithium. Stir the mixture for 1 h, then add a solution of the product of Example 8 (6.2 mmol) in ether by cannulation. Stir the mixture is stirred for 2 h, transfer to an ice bath, stir an additional 1.5 h, then quench with 5% NH4OH. Following extraction with saturated NaHCO3, water, and brine, dry the organic layer over anhydrous sodium sulfate, and evaporate. Purify the residue by silica gel flash chromatography using an ethyl acetate/hexane eluant to yield the title compound.

### EXAMPLE 6

(S)-tert-Butyl 3-hydroxy-3-(thiophen-2-yl)propylcarbamate. Degas all solvents and liquid reagents in this procedure with argon prior to their use in the reaction. Charge a 100 mL glass pressure tube attached to a hydrogen source, under argon, with trans-RuCl2[(R)-xylbinap][(R)-daipen] (0.0025 mmol; Ohkuma T et. al. J. Am. Chem. Soc 1998 120: 13529). Add a solution of about 1.5 mL of 2-propanol and 5 mmol of the product of Example 9, followed by 20 μL of 1.0 M potassium tert-butoxide in tert-butyl alcohol. Vacuum-argon cycle the mixture 5 times, then cycle it between brief vacuum application and hydrogen (2 atmospheres) 10 times. Place the vessel under 8 atmospheres of hydrogen and stir vigorously for 14 h. Allow the hydrogen to escape and concentrate the solution in vacuo, then purify the residue by silica gel flash chromatography using methanol/methylene chloride as eluant to yield the title compound.

### EXAMPLE 7

(S)-3-Amino-1-(thiophen-2-yl)propan-1-ol hydrochloride. Treat a 4 mmol portion of the product of Example 6 with 2.8 mL of 1 N HCl in dioxane. Allow the mixture to stand for 1 h, then evaporate to yield the title compound and use it without purification for subsequent reaction (store under argon).

### EXAMPLE 8

(S)-2,2,2-trifluoro-N-(3-(thiophen-2-yl)-3-(triethylsilyloxy)propyl)acetamide. Treat the entire product of Example 7 except for about a 1.5 mg retained sample, under argon, with 10 mL of DMF and 8.4 mmol of diisopropylethylamine, cool the solution in an ice bath, and add triethylsilyl chloride (4.2 mmol). Stir the mixture for 4 h, then add 4.2 mmol of diisopropylethylamine, followed dropwise by 4.2 mmol of trifluoroacetic anhydride. Stir the solution for about 15 h, warming slowly to room temperature, then pour into 30 mL each of pH 7 buffer and ether. Separate the aqueous layer and extract it 2× with additional ether. Wash the combined organic layers twice with brine, dry over anhydrous sodium sulfate, and evaporate. Purify the residue by silica gel flash chromatography using ethyl acetate/hexane eluant to yield the title compound.

### EXAMPLE 9

(S)-2,2,2-trifluoro-N-(3-(thiophen-2-yl)-3-(triethylsilyloxy)propyl)-N-(trideuteromethyl)acetamide. Treat a solution of 3 mmol of the product of Example 8 in 6 mL of DMF, under argon in an ice bath, with 3.3 mmol of 60% NaH in mineral oil. Stir the mixture for 4 h, then add methyl-d₃ iodide (6 mmol). Remove the ice bath and stir the mixture for about 40 h, then again cool in an ice bath. Add pH 7 buffer to quench the reaction and pour the mixture into 20 mL each of pH 7 buffer and ether. Separate the organic layer and wash with brine, dry over anhydrous sodium sulfate, and evaporate. Take up the residue in acetonitrile and extract it with hexanes (3×) to remove mineral oil. Back extract the combined hexanes layers with acetonitrile and combine the acetonitrile layers, evaporate, and purify by silica gel flash chromatography using ethyl acetate/hexane eluant to yield the title compound.

### EXAMPLE 10

(S)-3-(thiopen-2-yl)-N-(trideuteromethyl)-3-(triethylsilyloxy)propan-1-amine. Dissolve a solution of 2.5 mmol of the product of Example 9 in 5 mL of methanol and treat it under argon with 4 mmol of powdered K₂CO₃. Stir the mixture for 4 h, then pour it into 20 mL each of pH 7 buffer and ether. Separate the aqueous layer and wash again 2× with ether, combine the organic layers, wash with brine, dry over MgSO₄, and evaporate. Use the oily product directly in subsequent reactions.

### EXAMPLE 11

(S)-N-(5′-dibenzosuberyl)-N-trideuteromethyl-3-(thiophen-2-yl)-3-(triethylsilyloxy)propan-1-amine. Take up the entire product of Example 14 except for about a 2 mg retained sample in 6 mL of methylene chloride and treat with 2.5 mmol each of diisopropylethylamine and dibenzosuberyl chloride (ABCR GmbH), then stir for 16 h at room temperature. Concentrate the solution and purify the product by silica gel flash chromatography using ethyl acetate/hexanes eluant to yield the title compound.

### EXAMPLE 12

(S)-3-(5′dibenzosuberyl(trideuteromethyl)amino)-1-(thiophen-2-yl)propan-1-ol. Treat a solution of 1.8 mmol of the product of Example 15 in 10 mL of methylene chloride under argon with 1.8 mmol of tetrabutylammonium fluoride. After 2 h, extract the solution with 20 mL each of saturated NaHCO₃ and ether. Separate the aqueous layer and wash again 2× with ether, combine the organic layers, wash with brine, dry over MgSO₄, and evaporate. Purify by silica gel flash chromatography using methylene chloride/methanol/ammonium hydroxide eluant to yield the title compound.

### EXAMPLE 13

(S)-N-3-(naphthalen-1-yloxy)-3-(thiophen-2-yl)propyl)-N-(trideuteromethyl)-5′-dibenosuberylamine. Treat a solution of 1.2 mmol (S)-(−)-N,N-dimethyl-3-hydroxy-3-(2-thienyl)propanamine in 1.5 ml of dimethylsulfoxide at ambient temperature under argon with 47 mg of sodium hydride as a 60% dispersion in mineral oil and stirred vigorously. After 30 minutes of stirring, add 35 mg of potassium benzoate, and continue stirring for an additional 10 minutes. Add 1.2 mmol of 1-fluoronaphthalene and stir the mixture at 50° C. for 17 hours. Pour the reaction mixture into 15 ml of cold water, and adjust the pH to 4.8 by addition of acetic acid. Add 5 mL of hexane, stir the mixture for 10 minutes, and separate the layers. Stir the aqueous phase again with 5 ml of hexane and separate the phases. Adjust the pH of the aqueous phase to 12.5 by addition of aqueous sodium hydroxide, and add 15 ml of ethyl acetate. Stir the basic mixture at ambient temperature for 10 minutes, and separate the layers. Extract the aqueous phase with another 15 ml portion of ethyl acetate, and combine the organic extracts, wash with 30 ml of water, dry over magnesium sulfate, and evaporate under vacuum. Dissolve the oily residue the minimal amount of 1:1 ethyl acetate:hexane and apply to a pad of silica gel using methylene chloride/methanol/concentrated ammonium hydroxide as eluant. Evaporate the product fraction under vacuum to obtain the title product.

### EXAMPLE 14

(S)-2,2,2-trifluoro-N-(3-(thiophen-2-yl)-3-(triethylsilyloxy)propyl)-N-(¹³C-trideuteromethyl)acetamide. React a solution of 3.6 mmol of the product of Example 8 with 8 mmol of iodomethane-¹³C,d3 using the procedure described in Example 9. Purify by silica gel flash chromatography using ethyl acetate/hexane eluant to obtain the title compound.

### EXAMPLE 15

(S)-3-(5′dibenzosuberyl(¹³C-trideuteromethyl)amino)-1-(thiophen-2-yl)propan-1-ol. N-Deacylate a 3.1 mmol portion of the product of Example 21 with K₂CO₃ in methanol using the method described in Example 10 to yield the title compound, which was used for subsequent reaction without purification.

### EXAMPLE 16

(S)-N-(5′-dibenzosuberyl)-3-(thiophen-2-yl)-N-(¹³C-trideuteromethyl)-3-(triethylsilyloxy)propan-1-amine. React one half of the product of Example 15 with 1.6 mmol of dibenzosuberyl chloride by the method described in Example 11. Purify the crude reaction product using silica gel flash chromatography with ethyl acetate/hexanes eluant to yield the title compound.

### EXAMPLE 17

(S)-3-(5′dibenzosuberyl(¹³C-trideuteromethyl)amino)-1-(thiophen-2-yl)propan-1-ol. Desilylate a solution of 1.2 mmol of the product of Example 16 is tetrabutylammonium fluoride by the method described in Example 12. Purify the crude product by silica gel flash chromatography using methylene chloride/methanol/ammonium hydroxide eluant to yield the title compound.

### EXAMPLE 18

(S)-N-3-(naphthalen-1-yloxy)-3-(thiophen-2-yl)propyl)-N-(¹³C-trideuteromethyl)-5′-dibenosuberylamine. React a 0.9 mmol sample of the product of Example 17 with 0.9 mmol of 1-fluoronaphthalene by the procedure described in Example 13. Purify the crude product by silica gel flash chromatography using methylene chloride/methanol/concentrated ammonium hydroxide as eluant to yield the title product.

### EXAMPLE 19

(S)-3-(naphthylen-1-yloxy)-3-(thiophene-2-yl)-N-(¹³C-trideuteromethyl)propan-1-amine trifluoroacetic acid salt (Compound 11, wherein the carbon atom attached to Y9a-9c is replaced with ¹³C). Dissolve the product of Example 18 (0.52 mmol) in 3 mL of formic acid and allow to stand at room temperature for 1.5 h until TLC indicates disappearance of starting material. Evaporate the mixture in vacuo. Adjust the pH of a portion of brine to 11 with 50% NaOH and partitione the residue between 15 mL each of this basic brine solution and methylene chloride. Extract the aqueous layer 2× with additional methylene chloride combine the organic layers, dry over MgSO₄, and evaporate. Purify by reversed-phase HPLC using an acetonitrile/water (0.1% TFA) gradient to yield the title compound.

### EXAMPLE 20

4-Deutero-1-fluoronaphthalene. Cool a solution of 1-Bromo-4-fluoronaphthalene (8.4 mmol) in 25 mL of ether under argon in acetone/dry ice and treat during about 10 min with 8.4 mmol of 2 N N-butyllithium. Stir the mixture for 1 h, then quench by dropwise addition of deuterium oxide (0.5 mL). Stir the mixture for 10 min, remove the cold bath and continue stirring for an additional 2 h, then extract the mixture with brine, dry over anhydrous sodium sulfate, and evaporate. Kugelrohr distill the residue to yield the title compound.

### EXAMPLE 21

(S)-3-(4-deuteronaphthen-1yloxy)-N,N-dimethyl-3-(thiophene-2-yl)propan-1-amine. Using the general procedure outlined in Example 2, react 3.3 mmol of the product of Example 20 with 3.3 mmol of (S)-(−)-N,N-dimethyl-3-hydroxy-3-(2-thienyl)propanamine. Filter through a silica gel pad as described in Example 2 to yield the oily title compound.

### EXAMPLE 22

(S)-3-(4-deuteronaphthalen-1-yloxy)-N-methyl-3-(thiophene-2-yl)propan-1-amine (Compound 1). Using the procedure described in Example 3, N-demethylate a 1.3 mmol portion of the product of Example 21. Crystallize the crude product from acidified ethyl acetate as described in Example 3 to yield the off-white title product.

### EXAMPLE 23

(S)-N-(3-(4-deuteronaphthalen-1-yloxy)-3-(thiophen-2-yl)propyl)-N-(trideuteromethyl)-5′-dibenosuberylamine. React the product of Example 20 (2.2 mmol) with the product of Example 12 (2.2 mmol) using the procedure outlined in Example 17. Workup through a silica gel pad as described in that Example yields the title compound.

### EXAMPLE 24

(S)-3-(4-deuteronaphthalen-1-yloxy)-3-(thiophene-2-yl)-N-(trideuteromethyl)propan-1-amine trifluoroacetic acid salt (Compound 90). N-deprotected the product of Example 23 (0.5 mmol) with formic acid according to the procedure outlined in Example 19. Purify the crude product using reversed-phase chromatographic purification as described in that Example to yield the title compound.

### EXAMPLE 25

(S)-N-(3-(4-deuteronaphthalen-1-yloxy)-3-(thiophen-2-yl)propyl)-N-(¹³C-trideuteromethyl)-5′-dibenosuberylamine. React the product of Example 20 (1.7 mmol) with the product of Example 17 (1.7 mmol) using the procedure outlined in Example 13. Work up through a silica gel pad as described in that Example to yield the title compound.

### EXAMPLE 26

(S)-3-(4-deuteronaphthalen-1-yloxy)-3-(thiophene-2-yl)-N-(¹³C-trideuteromethyl)propan-1-amine trifluoroacetic acid salt (Compound 90, wherein the carbon atom attached to Y9a-9c is replaced with ¹³C). N-deprotect the product of Example 25 (1.1 mmol) with formic acid according to the procedure outlined in Example 19. Purify the crude product by reversed-phase chromatography as described in that Example to yield the title compound.

### EXAMPLE 27

Part 1. (S)-3-(dimethylamino)-1-deutero-1-(thiophen-2-yl)propan-1-ol. Use oven-dried glassware for the reactions described in this example. Dissolve a 40.5 mmol portion of (2R,3S)-(−)-4-dimethylamino-1,2-diphenyl-3-methyl-2-butanol in toluene, pre-dried over MgSO₄, and concentrated in vacuo. Add the dry residue to 30 mL of dry THF and cool the mixture in an acetone/CO₂ bath. Add a solution of 41 mmol of n-BuLi (2 N solution in hexanes) and stir the mixture for 10 min. Add 1 mL of D₂O dropwise and is allow the mixture to warm to room temperature, then evaporated in vacuo. Partition the residue between 3 mL D₂O and toluene (2×20 mL). Combine the organic layers, dry over MgSO₄, and concentrate to yield the O-deuterated species.

Part 2. Dissolve 3-(Dimethylamino)-1-(thiophen-2-yl)propan-1-one (Robertson D W et. al. U.S. Pat. No. 5,023,269 to Eli Lilly; 12.3 mmol) in 15 mL each of saturated sodium bicarbonate and methylene chloride. Extract the aqueous layer with additional methylene chloride (2×), combine the organic layers, dry over anhydrous MgSO₄, and concentrate to yield the free base.

Part 3. Cool a 1 N solution of LiAlD4.2THF in toluene (18.9 mmol) to about −30° C. under argon and treat via cannula with the above-prepared (2R,3S)-(−)-4-dimethylamino-1,2-diphenyl-3-methyl-2-butanedeuteroxide as a solution in 6 mL of toluene. Wash the flask and cannula using an additional 2 mL of toluene, cool the mixture in a CO₂/acetone bath for 10 min, and treated via cannula with 8.1 mmol of 3-(dimethylamino)-1-(thiophen-2-yl)propan-1-one free base as a solution in 5 mL of toluene. Stir the mixture for about 18 h in the cold, then replace the acetone/CO₂ bath with an ice/water bath. After an additional 30 min, cautiously treat the mixture dropwise with 0.72 mL of water during 15 min, then add 0.72 mL of 15% aqueous NaOH dropwise, and finally add 2.16 mL of water dropwise. Filter the suspension through a pad of diatomaceous earth, washing the pad 2× with THF. Concentrate the filtrate in vacuo, then partition between hexanes (40 mL) and 50% aqueous methanol (8×20 mL). Combine the aqueous layers and wash with hexanes, then concentrat in vacuo. Crystallize the residue twice from ca. 1:2 methanol/water to yield the title product.

### EXAMPLE 28

(S)-3-Deutero-N,N-dimethyl-3-(naphthalen-1-yloxy)-3-(thiophen-2-yl)propan-1-amine. React a 1.4 mmol portion of the product of Example 27 with 1.4 mmol of 1-fluoronaphthalene according by the general method described in Example 2 to yield the title compound.

### EXAMPLE 29

(S)-3-Deutero-N-methyl-3-(naphthalen-1-yloxy)-3-(thiophen-2-yl)propan-1-amine (Compound 16). N-Demethylate a 0.82 mmol portion of the product of Example 28 according to the general procedure outlined in example 3 to yield the title compound.

### EXAMPLE 30

(S)-3-Deutero-N,N-dimethyl-3-(4-deuteronaphthalen-1-yloxy)-3-(thiophen-2-yl)propan-1-amine. React a 2.1 mmol portion of the product of Example 28 with 2.1 mmol of the product of Example 20 according by the general method described in Example 2 to yield the title compound.

### EXAMPLE 31

(S)-3-Deutero-N-methyl-3-(4-deuteronaphthalen-1-yloxy)-3-(thiophen-2-yl)propan-1-amine (Compound 95). N-demethylate a 1.6 mmol portion of the product of Example 37 by the general method described in Example 3 to yield the title compound.

### EXAMPLE 32

(S)-3-Deutero-N,N-dimethyl-3-(2,3,4,5,6,7,8-heptadeuteronaphthalen-1-yloxy)-3-(thiophen-2-yl)propan-1-amine. React a 1.4 mmol portion of the product of Example 27 with 1.4 mmol of the product of Example 1 according to the general method described in Example 2 to yield the title compound.

### EXAMPLE 33

(S)-3-Deutero-N-methyl-3-(2,3,4,5,6,7,8-heptadeuteronaphthalen-1-yloxy)-3-(thiophen-2-yl)propan-1-amine (Compound 648). N-deprotect a 1.0 mmol portion of the product of Example 32 using the general method described in Example 3 to yield the title compound.

### EXAMPLE 34

Ex-vivo inhibition of rat synaptosome serotonin and norepinephrine transport. Inhibition of the accumulation of [³H]-serotonin into rat whole brain synaptosomes and [³H]-norepinephrine into synaptosomes from rat frontal plus temporal cortex is measured essentially according to literature methods (Hyttel J, Prog. Neuropharmacol. Biol. Psychiatry 1982 6: 177). Briefly, rats are decapitated and the relevant brain tissue is rapidly removed and homogenized in 40 vol (w/v) ice-cold 0.32 M sucrose solution. The synaptosomal fraction (P2) is isolated by centrifugation at 600 g for 10 min, and the supernatant is centrifuged at 20,000 g for 55 min. The pellet (P2) is resuspended in modified Krebs-Ringer phosphate buffer [122 mM NaCl, 5 mM KCl, 972 mM CaCl₂, 1.2 mM MgSO₄, 10 mM glucose, 101 mM ascorbic acid, 161 mM ethylenediamine tetraacetic acid (EDTA), 16 mM phosphate buffer, pH 7.4]. [³H]-serotonin (10 nM) and [³H]-norepipnephrine (10 nM) are added and the samples are incubated with varying concentrations of a compound of this invention or a vehicle only control. The norephinephrine transporter assay is incubated at room temperature for 5 min and the serotonin transporter assay is incubated for 5 min at 37° C. For all assays the incubation is terminated by rapid vacuum filtration using the assay buffer as filtration buffer. Background activities in the serotonin and norephinephrine assays are defined as counts in the presence of 10 μM, respectively, of citalopram and talsupram. Each of the tested compounds shows active inhibition of both serotonin and norepinephrine uptake.

### EXAMPLE 44

Neuropathic pain model. An experimental model of neuropathic pain is generated as describe by Kim and Chung (Pain 1992 50: 355). Briefly, surgery is carried out on anesthetized rats to tightly ligate both the L5 and L6 spinal nerves one side of a rat (the “Chung model”). Following a 3-week recovery period, the animals are administered varying amounts of a compound of this invention via oral gavage or a vehicle only control. Animals are then tested over a 6 hour period (at 1, 2, 4, and 6 hours) for withdrawal latencies to application of cold induced by acetone or methylene chloride evaporation on the foot (cold allodynia measurement), using both pre-operation withdrawal latencies and the contralateral size of the animal as internal controls. Sensitivity of the hind paw to stimulation with calibrated von Frey filaments is conducted to measure mechanical hyperalgesia. Each of the compounds tested shows activity in both mechanical hyperalgesia and cold allodynia.

### EXAMPLE 45

Inflammatory and central pain model. Injection of formalin into the paw of rats causes a biphasic shaking and licking response that can be quantified by counting the number of shaking or licking responses. Male SD rats (80-100 g) are injected subcutaneously with a compound of this invention dissolved in 0.1% methyl cellulose (MC)-saline or solvent only. After 30 minutes, 50 μL of a 2% formalin solution are injected into a hind paw. Periods of licking and shaking are recorded in 5 minute intervals for 1 hour following the formalin injection. The early phase of the formalin response is measured as licking/shaking between 0-5 minutes, and the late phase is measured from 15-50 minutes and is expressed as % inhibition compared to the respective vehicle group. This testing method is known to those skilled in the art and described in, for example, Iyengar, S et. al. J. Pharm. Exp. Ther. 2004 311: 576; Follenfant R L et. al., Br. J. Pharmacol. 1988 93: 85; Rogers H et. al., Br. J. Pharmacol. 1992 106: 783, the disclosure of which is herein incorporated by reference. Each compound tested actively inhibits the late-phase formalin response.

All references cited herein, whether in print, electronic, computer readable storage media or other form, are expressly incorporated by reference in their entirety, including but not limited to, abstracts, articles, journals, publications, texts, treatises, technical data sheets, internet web sites, databases, patents, patent applications, and patent publications

The recitation of a listing of chemical groups in any definition of a variable herein includes definitions of that variable as any single group or combination of listed groups. The recitation of an embodiment for a variable herein includes that embodiment as any single embodiment or in combination with any other embodiments or portions thereof.

In one embodiment, the compound or mixture of compounds is isolated. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

I claim:

1. A compound of formula I: 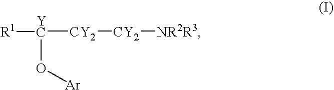
or a prodrug thereof; or a pharmaceutically acceptable salt of said compound or prodrug; or a solvate, hydrate, and/or polymorph of said compound, salt, prodrug, or prodrug salt wherein:
each Y is independently selected from H or deuterium;
R¹ is C₅-C₇ cycloalkyl, thienyl, halothienyl, (C₁-C₄ alkyl) thienyl, furanyl, pyridyl, thiazolyl;
Ar is 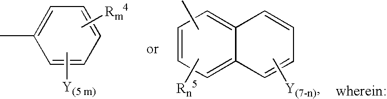
each R⁴ is independently selected from halo, C₁-C₄ alkyl, C₁-C₃ alkoxy or trifluoromethyl;
each R⁵ is independently selected from halo, C₁-C₄ alkyl or trifluoromethyl;
m is 0, 1 or 2; and
n is 0 or 1;
each of R² and R³ is independently selected from hydrogen, deuterium or CY₃; and
each carbon atom is optionally replaced with ¹³C, wherein at least one Y is deuterium.

2. The compound according to claim 1, wherein at least one Y in Ar, R² or R³ is deuterium.

3. The compound according to claim 2, wherein at least one Y in Ar at a position subject to oxidative metabolism in humans is deuterium.

4. The compound according to claim 3, wherein Ar is napthylenyl, and at least one Y in the 4, 5, or 6 position of said napthylenyl is deuterium.

5. The compound according to claim 1, wherein R¹ is selected from halothienyl, (C₁-C₄ alkyl)thienyl, or thienyl.

6. The compound according to claim 5, wherein R¹ is thienyl.

7. The compound according to claim 1, wherein one of R² and R³ is selected from hydrogen or deuterium and the other is CY₃.

8. The compound according to claim 7, wherein at least one, two or all three Y in said CY³ are deuterium.

9. The compound according to claim 1, wherein both R² and R³ are independently selected from hydrogen or deuterium.

10. The compound according to claim 1, wherein said compound is a substantially isolated isostereomer.

11. A compound of the formula: 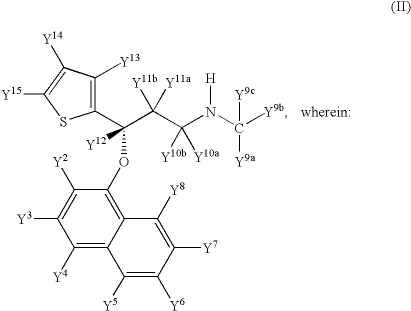
each Y is independently selected from H or deuterium;
the proton attached to N is optionally replaced by deuterium;
at least one Y is deuterium; and
one or more carbon atoms is optionally replaced with ¹³C.

12. The compound according to claim 11, selected from 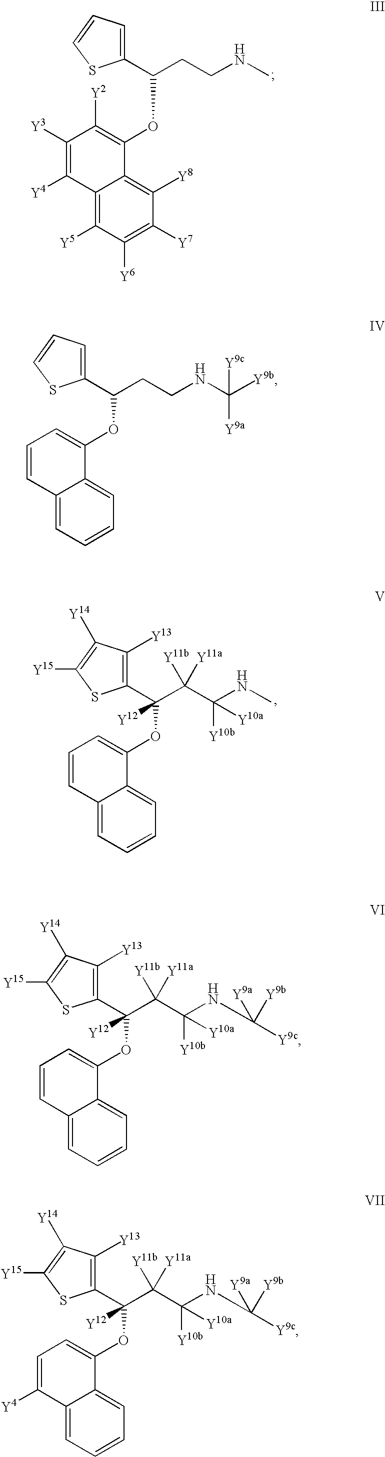 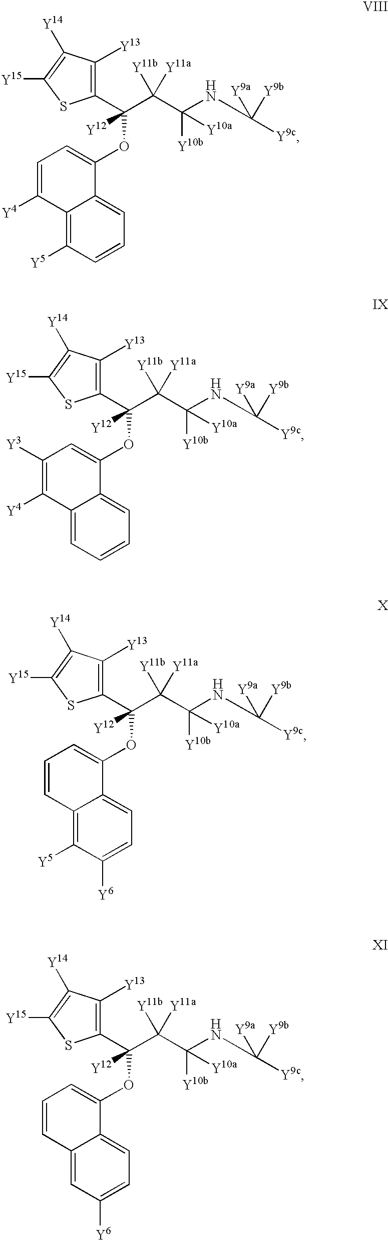 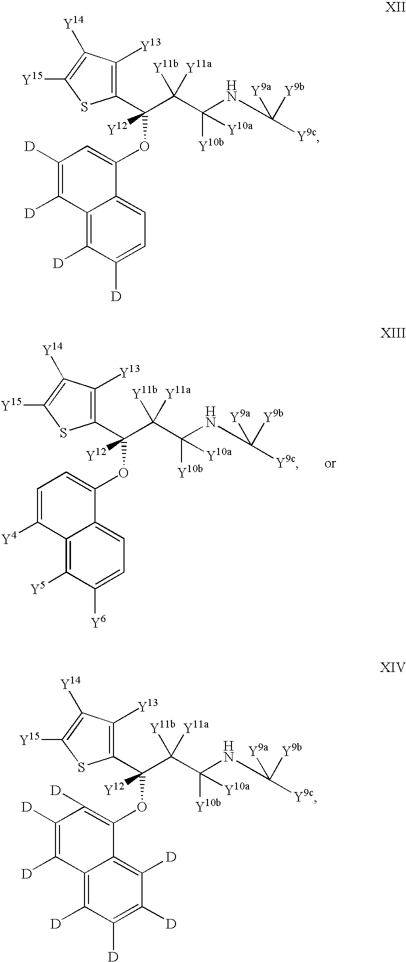
wherein in each compound chosen from formulas III-XI and XIII, at least one Y is deuterium; the H attached to N is optionally replaced with deuterium, and one or more carbons are optionally replaced by with ¹³C.

13. The compound according to claim 12, wherein said compound is selected from any one of a compound of formula III, VII, IX, X, XII, XIII or XIV.

14. The compound according to claim 13, wherein said compound is selected from any one of compound number 1 to 8, 88 to 166, 246 to 403, or 483 to 720 in Tables 1-13.

15. The compound according to claim 14, wherein said compound is selected from any one of compound number 1 to 8, 11, 90, 96, 169, 175, 248, 254, 327, 333, 406, 412, 485, 491, 564, 570, 643, or 649 in Tables 1-13.

16. The compound according to claim 15, wherein said compound is selected from any one of compound number 1 to 8, 90, 169, 248, 485, 564, or 643 in Tables 1-13.

17. A compound having Formula XXV: 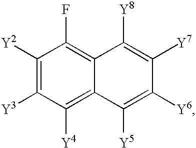
wherein each Y is independently selected from hydrogen or deuterium, wherein from one to six Y moieties are deuterium and wherein any carbon atom is optionally replaced with a ¹³C atom.

18. The compound according to claim 17, wherein Y³, Y⁴, Y⁵ and Y⁶ are deuterium.

19. A compound of formula XXVII, 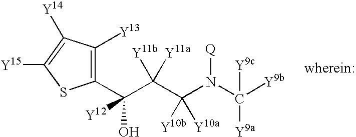
each Y is independently selected from hydrogen or deuterium;
Q is a removable nitrogen protecting group; and
at least one Y is deuterium.

20. A compound of formula XXVIII: 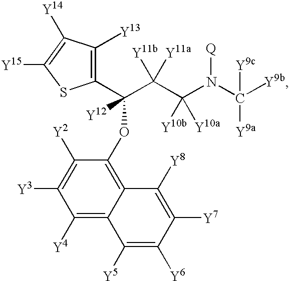
wherein each Y is independently selected from hydrogen or deuterium;
Q is a removable nitrogen protecting group; and
at least one Y is deuterium.

21. A mixture consisting essentially of:
a compound of formula I: 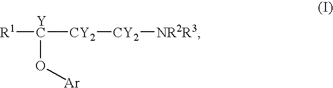
or a prodrug thereof; or a
pharmaceutically acceptable salt of said compound or prodrug; or a solvate, hydrate, and/or polymorph of said compound, salt, prodrug or prodrug salt; and
a. lighter isotopologues of said compound of formula I
wherein at least 50% of said mixture is said compound of formula I.

22. A mixture consisting essentially of:
a. a compound of formula I, or a prodrug thereof; or a pharmaceutically acceptable salt of said compound or prodrug; or a solvate, hydrate, and/or polymorph of said compound, salt, prodrug or prodrug salt; and
b. lighter isotopologues of said compound of formula I,
wherein at least 50% of the compounds in said mixture comprise an isotope at each position occupied by an isotope in the compound of formula I.

23. (canceled)

24. A composition comprising an effective amount of a compound of formula I, or a prodrug thereof; or a pharmaceutically acceptable salt of said compound or prodrug; or a solvate, hydrate, and/or polymorph of said compound, salt, prodrug or prodrug salt; and an acceptable carrier.

25. (canceled)

26. The composition according to claim 25 further comprising an effective amount of an additional therapeutic agent, wherein said additional therapeutic agent is useful for treating or preventing a condition selected from depression, obsessive-compulsive disease, aggressive disorder, premature ejaculation, cardiovascular disease, urinary tract disorders, psychosis, acute mania, anxiety, pain, sleep disorders; for reducing associated gastrointestinal side-effects of serotonin reuptake inhibitors; or for potentiating drug activity.

27. The composition according to claim 26, wherein said additional therapeutic agent is selected from a serotonin 1A receptor antagonist, a beta blocker, L-tryptophan or 5-hydroxy-L-tryptophan; a 5HT4 receptor antagonists, an antihypertensive, an atypical antipsychotic agent, an analgesic, a NSAID, a phosphodiesterase inhibitor, normotanephrine or a normetanephrine precursor, a sertindole derivative, an 8-aza-bicyclo[3.2.1]octan-3-ol derivatives of 2,3-dihydro-1,4-benzodioxan, an azaheterocyclylmethyl derivative of 7,8-dihydro-1,6,9-trioxa-3-aza-cyclopenta[a]naphthalene, an azabicyclylmethyl derivative of 2,3-dihydro-1,4-dioxino[2,3-f]quinoline, a 5-HT3 receptor antagonist, or a NK1 antagonist.

28. (canceled)

29. (canceled)

30. A method of treating a subject suffering from or susceptible to depression, pain, particularly diabetic neuropathy pain, attention-deficit/hyperactivity disorder, fibromyalgia, psoriasis, interstitial cystitis, incontinence, or for providing cardiovascular benefit through reduction or platelet activation state, said method comprising the step of administering to said subject a composition comprising an effective amount of a compound of formula I; and a pharmaceutically acceptable carrier.

31. The method according to claim 30, wherein the subject is treated to alleviate or prevent depression.

32. (canceled)

33. The method according to claim 33, wherein the pain is diabetic neuropathy pain.

34-41. (canceled)

42. A method of determining the concentration of a first compound having the formula: 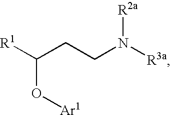
in a biological sample, wherein:
R¹ is selected from C₅-C₇ cycloalkyl, thienyl, halothienyl, (C₁-C₄ alkyl) thienyl, furanyl, pyridyl, or thiazolyl;
Ar is 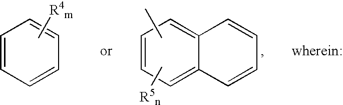
each R⁴ is independently selected from halo, C₁-C₄ alkyl, C₁-C₃ alkoxy or trifluoromethyl;
each R⁵ is independently selected from halo, C₁-C₄ alkyl or trifluoromethyl;
m is 0, 1 or 2; and
n is 0 or 1; and
each of R^{2a} and R^{3a} is independently selected from hydrogen or CH₃;
said method comprising the steps of:
a. adding a known concentration of a second compound to said biological sample, said second compound having the formula: 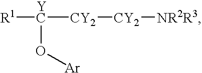
or an acid addition salt thereof, to said biological sample, wherein:
each Y is independently selected from H or deuterium;
Ar is 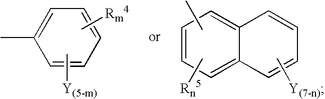
R¹ is the same as R¹ in said first compound;
each of R² and R³ is independently selected from:
i. hydrogen or deuterium if the corresponding R^{2a} or R^{3a} is hydrogen in said first compound, or
ii. CY₃ if the corresponding R^{2a} or R^{3a} is methyl in said first compound; and
each carbon atom in said second compound is optionally replaced with ¹³C, wherein at least one Y is deuterium; and
wherein the sum of Y moieties that are deuterium and carbon atoms that are replaced by ¹³C in said second compound is four or greater
b. subjecting said biological sample to a measuring device that distinguishes said first compound from said second compound;
c. calibrating said measuring device to correlate the detected quantity of said second compound with the known concentration of said second compound added to said biological sample; and
d. determining the concentration of said first compound in said biological sample by comparing the detected quantity of said first compound with the detected quantity and known concentration of said second compound.

43. (canceled)
